(19) United States
(12) Patent Application Publication
(10) Pub. No.: US 2007/0016354 A1
(43) Pub. Date: Jan. 18, 2007

(54) Method and device for determining a friction value representing frictions acting between a road and vehicle tires

(75) Inventors: Hans-Georg Engel, Sindelfingen (DE); Sinan Kazan, Los Altos, CA (US); Frank-Werner Mohn, Weil im Schonbuch (DE); Martin Wenz, Wildberg (DE); Richard Zimmer, Fellbach (DE)

Correspondence Address: FITCH, EVEN, TABIN & FLANNERY, P. O. BOX 18415, WASHINGTON, DC, 20036, US

(73) Assignee: DAIMERCHRYSLER AG, 70567 STUTTGART (DE)

(21) Appl. No.: 10/550,142

(22) PCT Filed: Mar. 19, 2004
(86) PCT No.: PCT/EP04/02916

§ 371 Date: Dec. 20, 2005

(30) Foreign Application Priority Data
Mar. 21, 2003 (DE) 103 19 787.9

(51) Int. Cl. G06F 17/00

(52) U.S. Cl. 701/80; 73/146

(57) ABSTRACT

The present invention relates to a method for determining a friction coefficient value (Fμ) which represents the coefficient of friction present between the underlying surface and a vehicle tire. For this purpose, a wheel slip value (λij) is determined for at least one vehicle wheel, said value (λij) describing the wheel slip present at this vehicle wheel. The friction coefficient value (Fμ) is determined as a function of this wheel slip value (λij). For this purpose, during a predefined operating state of the vehicle wheel slip values (λij) are determined at various times, in particular successive times. The frequency distribution of values is determined for these wheel slip values (λij) or for axle-related slip values (λ_{VA} and λ_{HA}) which are determined as a function of these wheel slip values (λij). The friction coefficient value (Fμ) is determined by evaluating this frequency distribution of values.

The invention relates to a method and a device for determining a friction coefficient value which represents the coefficient of friction present between the underlying surface and a vehicle tire.

Such methods and devices are known from the prior art in a variety of modifications.

The document DE 37 05 983 A1 discloses a device for monitoring the rate of utilization of the prevailing coefficient of friction of the underlying surface when braking and/or accelerating a motor vehicle. For this purpose, the device has sensors for sensing the acceleration of the vehicle and the wheel speeds. The instantaneous wheel slip is determined from these variables for at least one wheel and a function is formed which represents the functional dependence of the wheel slip on the acceleration of the vehicle. The function which is determined in this way is compared with stored slip characteristic curves in order to select the slip characteristic curve which comes closest to the function and thus corresponds to the current state of the underlying surface. The ratio between the maximum sensed acceleration value and the maximum of the slip characteristic curve is then formed. This ratio is a measure of how far away the wheels are from locking or spinning, i.e. how large the rate of utilization of the current coefficient of friction of the underlying surface.

The document DE 44 35 448 A1 discloses a method for permanently determining the coefficient of friction of the underlying surface. For this purpose, the utilization of the coefficient of adhesion in the longitudinal direction of the vehicle and the utilization of the coefficient of adhesion in the lateral direction of the vehicle are determined for the individual wheels by means of a mathematical tire model to which the wheel slip and slip angle variables which are determined for the individual wheels are fed as input variables. The present overall rate of utilization of the coefficient of adhesion is determined from these rates of utilization of the coefficient of adhesion. The overall acceleration of the vehicle is determined as a function of the determined longitudinal acceleration of the vehicle and the determined lateral acceleration of the vehicle. A ratio is then formed between the two values for the overall rate of utilization of the coefficient of adhesion and the overall acceleration of the vehicle in order to determine the present coefficient of friction of the underlying surface.

The document DE 43 00 048 A1 discloses a method for determining the adhesion/slip characteristic curve. For this purpose, the profile of the respective tire characteristic curve in the entire coefficient of adhesion/slip diagram is obtained in the driving mode of the vehicle from measured value pairs of the slip and of the coefficient of adhesion utilized with a given slip. The rate of utilization of adhesion which is associated with the respective value of the brake slip is determined computationally as a function of the measured braking deceleration of the vehicle, of the rear axle load component and of the wheelbase-related height of the center of gravity of the vehicle.

Japanese laid-open patent application JP 11248438 A discloses a method for determining the coefficient of friction in which the coefficient of friction is determined as a function of the determined wheel slip and the acceleration of the vehicle.

Taking the known prior art as a starting point, the following object for the person skilled in the art becomes apparent: the intention is to provide a slip-based method or a corresponding device for determining a friction coefficient value which represents the coefficient of friction which is present between the underlying surface and a vehicle tire and which makes this determining process possible using easier means, i.e. with less technical outlay, compared to the methods and devices known from the prior art.

This object is achieved by means of the features of claim 1 and by means of the features of claim 29.

In the method for determining a friction coefficient value which represents the coefficient of friction present between the underlying surface and a vehicle tire, a wheel slip value is determined for at least one vehicle wheel, said value describing the wheel slip present at this vehicle wheel. The friction coefficient value is determined as a function of this wheel slip value.

According to the invention, during a predefined operating state of the vehicle, wheel slip values are determined at various times, in particular successive times, and the frequency distribution of values is determined for these wheel slip values or for axle-related slip values which are determined as a function of these wheel slip values. This frequency distribution of values is evaluated in order to determine the friction coefficient value.

The further interesting aspect arises from the use of the method according to the invention in a warning system which uses a navigation system to determine the course of the road over the stretch in front of the vehicle and which uses a display device to indicate hazardous locations such as bends and/or traffic circles and/or intersections in the course of the road to the driver by including road signs symbolizing hazardous locations in the display.

Two embodiments are specified below for the implementation of the method according to the invention and of the device according to the invention.

Advantageous refinements may be found in the description and the drawing. The advantageous refinements which are obtained from any desired combination of the subject matters described in the subclaims are also to be included. The advantageous combination of the individual technical aspects of the two embodiments or the combination of both embodiments is as such also conceivable.

The two embodiments of the method according to the invention and respectively of the device according to the invention are described in more detail below with reference to the drawing, in which:

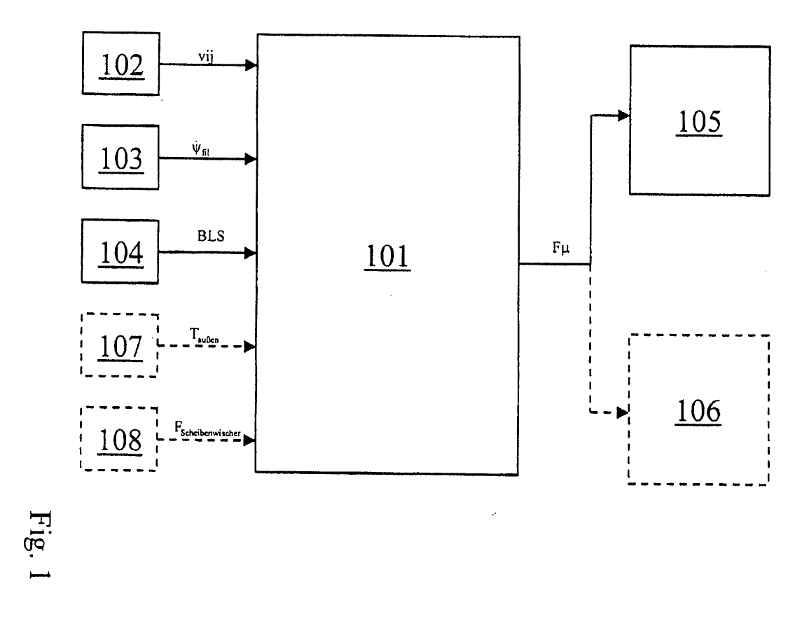

FIG. 1 is a schematic illustration of the device according to the invention for the first embodiment in the form of a block circuit diagram,

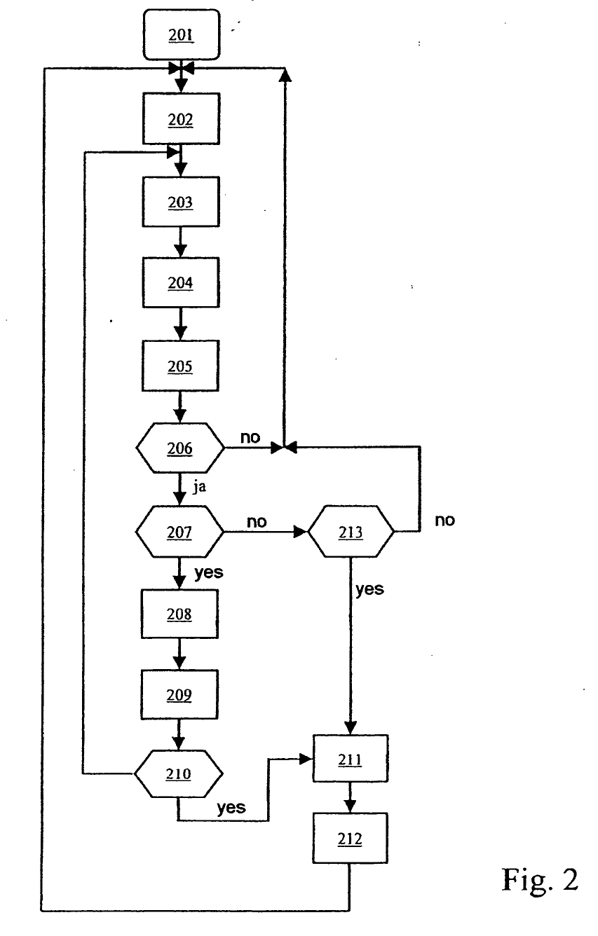

FIG. 2 is a flowchart showing the method according to the invention which runs in the device according to the invention for the first embodiment,

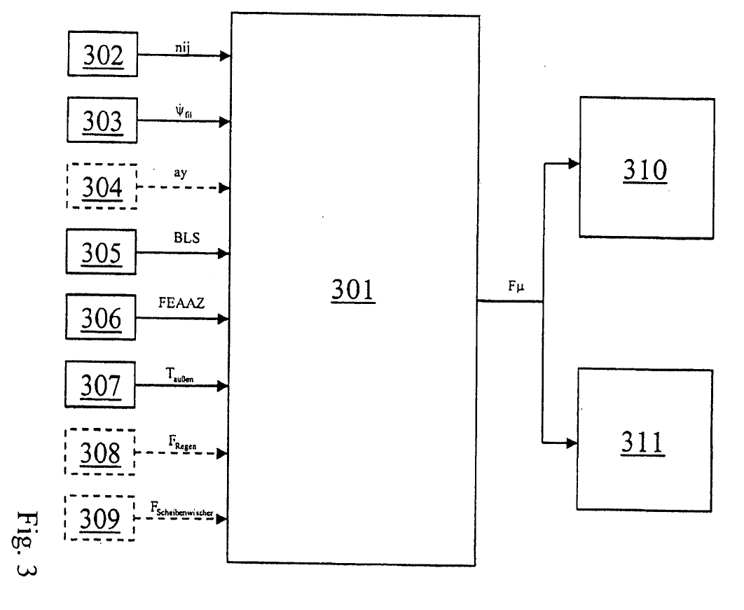

FIG. 3 gives a schematic illustration of the device according to the invention for the second embodiment in the form of a block circuit diagram,

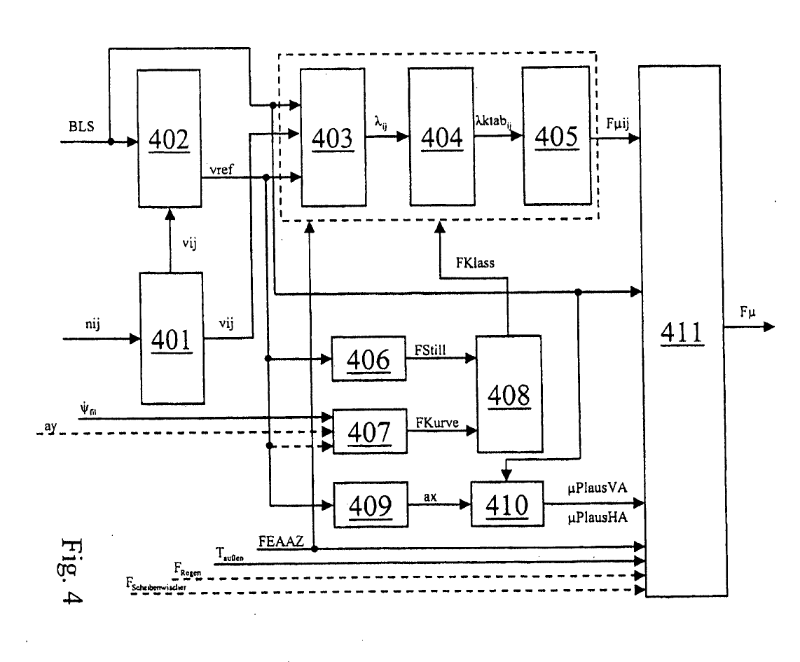

FIG. 4 is a schematic illustration of the core of the device according to the invention for the second embodiment in the form of a block circuit diagram,

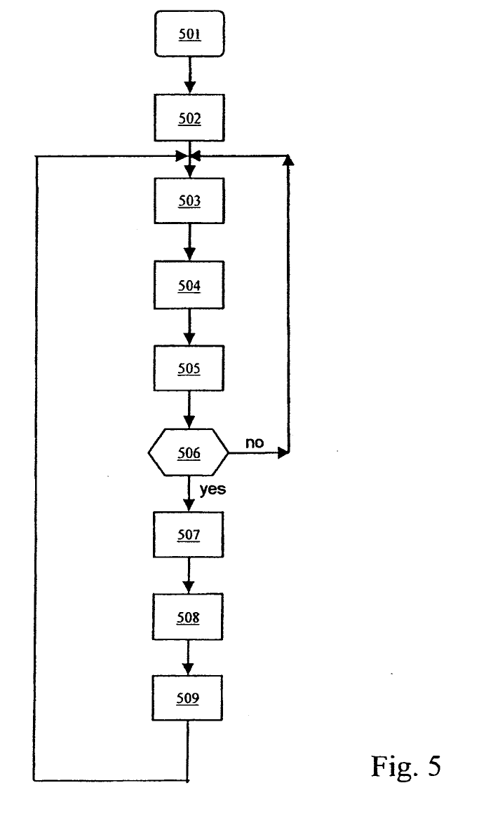

FIG. 5 is a flowchart showing the method according to the invention which runs in the device according to the invention for the second embodiment,

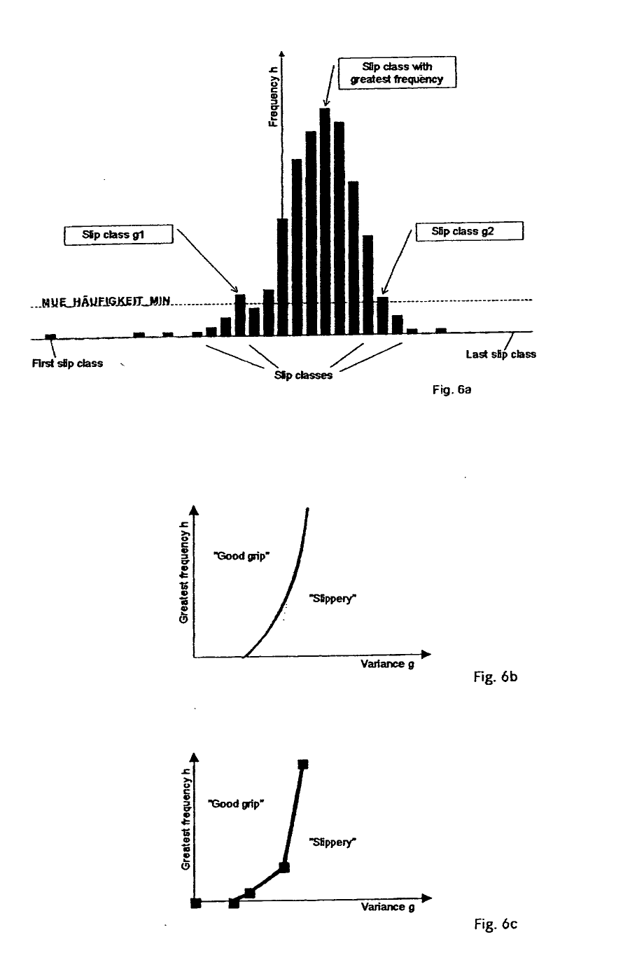

FIG. 6a shows a frequency distribution of values for the second embodiment,

FIG. 6b shows a first decision criterion which is applied in the second embodiment, and

FIG. 6c shows a second decision criterion which is applied in the second embodiment.

The first embodiment of the method according to the invention and, respectively, of the device according to the invention will be described in the text which follows, starting with FIG. 1.

Block 101 represents the core of the device according to the invention. In this block 101 the method according to the invention runs, and said method is illustrated in FIG. 2 using a flowchart and described below in detail.

Different input variables are fed to the block 101 in order to carry out the method according to the invention. Wheel r.p.m value vij which describe the wheel speeds of the individual vehicle wheels are fed to the block 101 from a block 102. The block 102 comprises wheel speed sensors which are assigned to the individual vehicle wheels and conversion means with which the sensed wheel speeds are converted into wheel r.p.m values. The wheel speed sensors and the conversion means can be embodied structurally separate from one another or each wheel speed sensor can have a corresponding conversion means. As an alternative to the wheel r.p.m values vii it is also possible to feed wheel speed values nij which describe the wheel speeds of the individual vehicle wheels to the block 101 from the block 102. In this case, the necessary conversion takes place in the block 101, and the block 102 comprises the wheel speed sensors which are assigned to the individual vehicle wheels. As an alternative, the wheel r.p.m value vij can also be made available to the block 101 from closed-loop and/or open-loop control devices contained in the vehicle. These closed-loop and/or open-loop control devices may be, for example, brake slip control devices and/or traction control devices and/or yaw rate control devices of the vehicle. The system of reference symbols used below in conjunction with the two values vij and nij has the following meaning: the index i indicates whether the value relates to a front wheel or a rear wheel. The index j indicates whether it relates to a left-hand or right-hand vehicle wheel.

A yaw rate value \dot{ψ}_{fil} which describes the filtered yaw rate is fed to the block 101 from a block 103. In this case, the block 103 comprises a yaw rate sensor and a corresponding filter means. In this context, the yaw rate sensor and the filter means may form one structural unit. However, the two components may also be arranged in a spatially separate fashion in the vehicle. As an alternative, an unfiltered yaw rate value may also be fed to the block 101. In this case, the necessary filtering is carried out in the block 101. As has already been stated in conjunction with block 102, the yaw rate value \dot{ψ}_{fil} or the unfiltered yaw rate value can also be made available to the block 101 by closed-loop and/or open-loop control devices contained in the vehicle, in particular by a device for controlling the yaw rate of the vehicle.

In addition, a signal BLS which is generated by a brake light switch 104 and which indicates whether or not the brake pedal is being activated by the driver is fed to the block 101.

In block 101, the method according to the invention runs by processing the input variables vij, \dot{ψ}_{fil} and BLS which are fed to it. With the method according to the invention a friction coefficient value Fμ is determined which represents the coefficient of friction which is present between the underlying surface and a vehicle tire. In this context, the friction coefficient value Fμ does not represent the value of the coefficient of friction but rather merely indicates whether the underlying surface is slippery or has good grip. That is to say with the friction coefficient value Fμ it is not possible to obtain definitive quantitative information but merely definitive qualitative information about the coefficient of friction, specifically information indicating whether the underlying surface is slippery or has good grip. As is apparent from the main use of the friction coefficient value Fμ which is described below, with this main use it is completely sufficient to be able to obtain definitive qualitative information about the coefficient of friction which is present between the underlying surface and a vehicle tire.

The friction coefficient value Fμ is fed from the block 101 to a block 105 which is a display device which is installed, for example, in the dashboard, in this case the display device is integrated in the combination instrument, or in the central console of the vehicle, in this case the display device may be associated with a navigation system. This display device can be used to indicate to the driver whether the vehicle is currently located on an underlying surface with a slippery surface or with a surface with good grip. The driver can be informed that he is driving over a slippery surface by, for example, including a snowflake on the display. As a result the driver can thus allow for a slippery underlying surface, for example during a driving off procedure.

The block 105, or the display device 105, is part of a warning system contained in the vehicle. For the sake of clarity, such a warning system has not been illustrated in FIG. 1. However, for the sake of better understanding, the functionality of such a warning system will be described below.

Such a warning system uses a navigation system to determine the course of the road over the stretch in front of the vehicle. Hazardous locations such as bends, traffic circles, intersections etc. are indicated to the driver in a display device, in this case the block 105 illustrated in FIG. 1, by including a road sign symbolizing the hazardous location in the display. For example, when the driver drives onto a bend and the curvature of this bend exceeds a specific amount, he is made aware of this bend in front of him by an appropriate warning symbol being included in the display, in this case there may be, for example, arrows. Two different embodiments of such a warning system are conceivable. In a first embodiment, a warning is issued only if the velocity of the vehicle exceeds a velocity threshold value corresponding to the hazardous location. In a second embodiment, a warning is issued and the information is thus included in the display, irrespective of the velocity of the vehicle.

As an alternative, further variables may be fed to the block 101, this being indicated by the dashed representation of the two blocks 107 and 108. On the one hand, a value T_{auβen} which describes the outside temperature may be fed to the block 101 from a block 107. On the other hand, a value F_{Scheibenwischer} which represents the operation of the windshield wiper can be fed to the block 101 from a block 108. These two values are not absolutely necessary for the implementation of the basic function of the method according to the invention but if they are available the method according to the invention can be improved by their evaluation. More details on the specific way in which the two values T_{auβen} and F_{Scheibenwischer} are taken into account will be given in the description of FIG. 2.

FIG. 1 illustrates a further option. This further option relates to the outputting and evaluation of the friction coefficient value Fμ. In addition to the friction coefficient value Fμ being fed to the display device 105, the friction coefficient value Fμ can also be fed to various closed-loop and/or open-loop control devices which are contained in the vehicle and which are represented by a block 106 which is illustrated by dashed lines. In this case, the information from the friction coefficient value Fμ can be used, for example, to modify the closed-loop and/or open-loop control algorithms of the closed-loop and/or open-loop control devices. Possible closed-loop and/or open-loop control devices are, by way of example, a brake slip control device and/or a traction control device and/or a yaw rate control device and/or an inter-vehicle distance control device. If the closed-loop and/or open-loop control devices which are listed above have been provided with the friction coefficient value Fμ, these devices can then make significantly better use of the forces which can be transmitted.

Furthermore, in the warning systems mentioned above it is also possible for the friction coefficient value Fμ to be processed. This processing then results in the information for the driver about bends, intersections etc. being output earlier, for example in the case of a slippery underlying surface, i.e. when the coefficient of friction is low.

Details are given below on the method according to the invention which is illustrated in FIG. 2 and which runs in the block 101 illustrated in FIG. 1.

The method according to the invention starts with the step 201 which is followed by a step 202. In the step 202, various initializing processes are carried out. Thus, in this step a timer t_{Zähler}, a predefined number of slip class counters λ_{kZähler} and a velocity change value indicator a_{Zeiger} are initialized. More details are given on the significance of the individual counters or pointers in the description of the following steps.

The step 202 is followed by a step 203 in which the input variables which are to be fed to the block 101 are made available. These are in particular the wheel r.p.m value vij and/or the yaw rate value \dot{ψ}fil and/or the signal BLS.

In a step 204 which follows the step 203, a velocity value vref which describes the vehicle reference velocity is determined. This is because the actual velocity of the vehicle over land is required to be able to determine wheel slips.

The method described below for determining the velocity value vref relates to a vehicle with rear wheel drive. Corresponding adaptations are necessary in a vehicle with front wheel drive or all-wheel drive.

In order to determine the velocity value vref as accurately as possible, two cases are differentiated: the case of driving and the case of braking. These two cases are differentiated by means of the signal BLS. In the case of driving, the brake light switch 104 is not activated. The signal generated by it ha, for example, the value 0. In contrast, in the case of braking the brake light switch 104 is activated. The signal generated by it has, for example, the value 1. That is to say the two cases of the case of driving and the case of braking are differentiated using a signal which is generated by a brake light switch 104.

In the case of driving, the velocity value vref is determined by forming mean values of the wheel r.p.m of the two wheels which are not driven. In the case of a vehicle with rear wheel drive, this is thus done by forming mean values of the wheel r.p.m vvj of the front wheels. In this context, the wheel r.p.m vvj of the front wheels are limited to the lower of the wheel r.p.m vhj of the rear wheels in order to improve the determination of the velocity value vref. The reason for this limitation is that in the case of driving a non driven wheel cannot be faster than a driven wheel.

In the case of braking, the velocity value vref is determined by forming mean values of the wheel r.p.m of the fastest wheel and of the second fastest wheel. The reason for this is as follows: in the case of braking, the two wheels which are braked to the greater extent, and are thus slower, are not used when the velocity value vref is being determined.

In addition, when the velocity value vref is being determined a gradient limitation is carried out. This gradient limitation is implemented as follows: as is apparent from the illustration in FIG. 2 the illustrated method is a cyclical method. Consequently, as long as the determination of the velocity value vref is running, a value for this velocity value vref is respectively determined for successive time steps which are spaced apart from one another at the intervals of the cycle time. The cycle time which is determined by the computing cycle of the processor which is used is typically of the order of magnitude of approximately 10 to 20 milliseconds. Owing to this short time interval between the individual time steps or times at which the velocity value vref is determined it is clearly apparent that the difference between the values in the velocity value vref which are determined for the successive time steps cannot assume a randomly large value. If it is detected that this difference exceeds a predetermined threshold value, the value of the velocity value vref is determined for the following time step on the basis of the value of the velocity value vref which was available for the preceding time step taking into account a value for the change in the velocity value vref which is the maximum possible one within a cycle time. This procedure constitutes a limitation.

The cycle time also predefines the timing pattern in which, for example, the values of the input variables are read in block 101.

At the beginning of the statements relating to the determination of the velocity value vref it was mentioned that in a vehicle with front wheel drive or all-wheel drive corresponding adaptations are necessary to the procedure for determining the velocity value vref. As is apparent from the statements above, these adaptations relate only to the case of driving. In a vehicle with front wheel drive, the velocity value vref is determined by forming mean values of the wheel r.p.m vvj of the rear wheels.

In a step 205 which follows the step 204, a velocity change value a_{xFilt}, which describes the acceleration behavior and/or deceleration behavior of the vehicle, is determined.

For this purpose, an unfiltered velocity change value aₛ is firstly determined from the velocity value vref by means of the following equation:
αaₓ(t)=(V_{ref}(t)−V_{ref}(t−1))/T (1).

In this context, the value T represents the cycle time which, as already mentioned, typically has a value from 10 to 20 milliseconds. The variable T designates the current time step. Accordingly, t−1 designates the preceding time step. Equation (1) forms a differential quotient. Of course, the unfiltered velocity change value aₓ may also be determined as a mathematically formulated velocity value vref over time.

In a further computational step, which also runs in the step 205 illustrated in FIG. 2, the velocity change value a_{xFilt}(t) is determined from the unfiltered velocity change value aₓ by filtering as a function of the change in the vehicle velocity using the equation
a_{xFilt}(t)=(aₓ(t−1)+aₓ(t))/2+df*aₓ(t) (2)
with df=max (0.1, abs ((V_{ref}(t)−V_{ref}(t−1))/V_{ref}(t)).

The expression max signifies that the larger in terms of value of the two values in brackets is selected. The expression abs signifies that the absolute value of the expression in brackets is formed.

The filter described by the equation (2) has the characteristic of a low pass filter. It forms mean values and is adjusted as a function of the velocity of the vehicle. To summarize: the velocity change value a_{xFilt} is formed as a function of the velocity value vref by forming a differential quotient or a derivative over time and subsequently filtering it, with mean values being formed by means of the filtering and being adjusted as a function of the velocity of the vehicle.

In step 206 which follows the step 205 it is determined whether or not cornering is taking place. For this purpose, the yaw rate value \dot{ψ}_{fil} is evaluated. In the present case it is checked whether the value of the yaw rate value \dot{ψ}_{fil} is smaller than a predefined threshold value. The predefined threshold value may be, for example, of the order of magnitude of approximately 0.6 degrees/second. If the value of the yaw rate value \dot{ψ}_{fil} is smaller than the predefined threshold value, which is equivalent to no distinct cornering occurring, the friction coefficient value Fμ can be determined, for which reason a step 207 is carried out subsequent to the step 206. If, on the other hand, the value of the yaw rate value \dot{ψ}_{fil} is greater than the predefined threshold value, which is equivalent to distinct cornering occurring, the friction coefficient value Fμ cannot be determined. For this reason, the system jumps back from step 206 to the step 202.

The interrogation which takes place in step 206 ensures that the friction coefficient value Fμ is carried out exclusively during straight-ahead travel. This is because when cornering different slip values occur at the two sides of the vehicle owing to the cornering movement and these values would cause falsification when determining the friction coefficient value.

However, for the case of cornering movement it is also possible to estimate the coefficient of friction which is present between the underlying surface and the vehicle tire. For this purpose, a modified procedure is necessary. For example, during a cornering movement it is also possible for a closed-loop control intervention to occur by means of a yaw rate control device even in the case of freewheeling. In order to be able to detect a closed-loop control intervention reliably even in this case, the signal of the yaw rate sensor must be evaluated. The minimum coefficient of friction value can also be determined in the case of freewheeling using the velocity value vref and the yaw rate value \dot{ψ}_{fil}, thus permitting the estimate of the coefficient of friction to be improved. For this purpose, a value for the longitudinal acceleration of the vehicle is determined as a function of the velocity value vref and the yaw rate value \dot{ψ}_{fil}. Said longitudinal acceleration value is compared with the velocity change value x_{xFilt} for example by forming quotients, and a minimum coefficient of friction coefficient value, which serves as an estimate of the coefficient of friction which is present between the underlying surface and the vehicle tire, can be determined from it.

In the step 207 which has already been mentioned, it is checked whether the absolute value of the velocity change value a_{xFilt}(t) is greater than a predefined threshold value. If this is the case, a step 208 is carried out following the step 207. In contrast, if this is not the case, a step 213 which is still to be described is carried out following the step.

In the step 208 which has already been mentioned, the timing counter t_{Zähler} is incremented. This can take place, for example, according to the relationship
t_{Zähler}=t_{Zähler}+T (3)

That is to say the timing counter t_{Zähler} is increased by the value of the cycle time T whenever the step 208 is processed. The incrementation of the timing counter which is performed in step 208 has the following significance: by means of the two interrogations which take place in the steps 206 and 207 it is detected whether there is a predefined operating state of the vehicle in which only the friction coefficient value Fμ is determined. This predefined operating state of the vehicle is defined by the yaw rate value \dot{ψ}_{fil} and/or the velocity change value a_{xFilt}(t). This predefined operating state of the vehicle is straight-ahead travel in which a minimum acceleration or a minimum deceleration of the vehicle is occurring. Incrementing the timing counter in step 208 has the purpose of documenting how long this predefined operating state of the vehicle has been present.

Following the step 208, a step 209 is carried out. In this step 209, the slip observation which is necessary according to the method according to the invention for determining the friction coefficient value Fμ is carried out. For this purpose, wheel slip values λij for the individual vehicle wheels are firstly determined in a known fashion as a function of the wheel r.p.m value vij and the velocity value vref.

With respect to the following statements it is to be remembered that a vehicle with a rear wheel drive which has two axles is used as the basis. In a vehicle with front wheel drive or in a vehicle with all-wheel drive, appropriate changes or adaptations are to be made to the following statements.

Taking the determined wheel slip values λij as a starting point, a slip value λ_{VA} is determined for the front axle and a slip value λ_{HA} is determined for the rear axle. For the front axle, the slip value λ_{VA} is determined by forming mean values from the two wheel slip values λ_{VJ}, i.e. the wheel slip values of the two front wheels. The same applies to the slip value λHA Of the rear axle. The two slip values λ_{VA} and λ_{HA} are used as the basis for the rest of the slip observation. Consequently, the slip observation is carried out on an axle basis. As an alternative which is also possible to provide for the slip observation to be generally carried out on a wheel-specific basis, i.e. by evaluating the wheel slip values λij. In this case, corresponding definitive information about the coefficient of friction which is present is then obtained for each of the vehicle wheels.

As for the determination of the velocity value vref, a differentiation between the case of driving and the case of braking is also made for the slip observation. In a vehicle with rear wheel drive the slip value λ_{HA} which is determined for the rear axle is evaluated in the case of driving. In contrast, in the case of braking the slip value λ_{VA} which is determined for the front axle is evaluated.

The actual slip observation occurs as follows: by means of driving trials it is determined in advance which value range is to be expected for the wheel slip values λij and thus for the axle-related slip values λ_{VA} and λ_{HA}. The overall value range which was determined here has been divided into individual slip classes. In this context the subdivision can be finer for smaller slip values, i.e. for small slip values the interval length of the individual slip class is smaller. In contrast, the subdivision in the direction of relatively large slip values can be larger, signifying that the interval length of the individual slip class is larger for relatively large slip values. Each of the slip classes which is determined in this way is assigned an associated slip class counter λ_{kZähler}.

As has already been stated in conjunction with step 204, the value for the velocity value vref is determined for each time step of the timing pattern which has been predefined by the cycle time. Consequently, wheel slip values λij and thus also axle-related slip values λ_{VA} or λHA are also present for each of these time steps.

Which of the two axle-related slip values is evaluated depends on whether it is a case of driving or a case of braking. The slip value to be evaluated is compared with the interval limits of the individual slip classes. If it is detected that the value of the slip value which is to be evaluated lies within one of these slip classes, the slip class counter λ_{kZähler} which is associated with this slip class is incremented.

As is apparent from the illustration in FIG. 2, the method according to the invention is a cyclical method. Consequently, the step 209 is carried out for as long as the conditions of the steps 206 and 20 are fulfilled, provided that the timing condition of the step 210 which is to be described below is fulfilled. That is to say the step 209 and thus the slip observation or classification of the slip values which take place in it is performed for a large number of successive times during a predefined operating state of the vehicle. This classification or sorting of the slip values into the individual slip classes results in a frequency distribution of values for the axle-related slip values.

To summarize: each time the step 209 is carried out an axle-related slip value λ_{VA} or λ_{HA} is determined. This slip value is then assigned to one of the slip classes as a function of its value. Here, the slip class counter λ_{kZähler} which is associated with the slip class is incremented. This process is repeated until the conditions of the steps 206 and 207 are fulfilled within the time frame defined by the interrogation contained in step 210. Consequently, this procedure results in a frequency distribution of values for the slip values.

As an alternative to the slip observation which is carried out on an axle basis as described above, the slip observation can also be carried out on a wheel-specific basis. This has the advantage that in this case it is also possible, for example, to detect what is referred to as μ-split situations. In addition, the slip observation which is carried out on a wheel-specific basis has the advantage that even very brief closed-loop control interventions such as are carried out, for example, by a yaw rate control device can be unambiguously detected. Against this background it would be appropriate to switch over from the axle-related slip observation to the wheel-specific slip observation when such brief closed-loop control interventions are present. Long closed-loop control interventions are sensed by the axle-related slip observation, for which reason wheel-specific closed-loop control interventions do not need to be carried out when such closed-loop control interventions occur.

In addition to the slip observation described above, the maximum value of the velocity change value a_{xFilt}(t) is also determined in step 209. For this purpose, whenever the step 209 is called, the current value of the velocity change of value a_{xFilt}(t) is firstly determined. This current value of the velocity change value a_{xfilt}(t) is compared with the value of the velocity change value pointer a_{Zeiger}. If it is detected during this comparison that the current value of the velocity change value a_{xFilt}(t) is larger than the value of the velocity change value pointer a_{Zeiger}, the current value of the velocity change value a_{xFilt}(t) is written over the value of the velocity change value pointer a_{Zeiger}. If, on the other hand, the current value of the velocity change value a_{xFilt}(t) is smaller than the value of the velocity change value pointer a_{Zeiger}, overwriting is not necessary.

The step 209 is followed by the step 210 which has already been mentioned above. In this step 210, an interrogation is used to check whether the value of the timing counter t_{Zähler} is larger than a predefined first timing threshold value which corresponds, for example, to a time period of 10 seconds. If this is not the case, the system jumps back from the step 210 to the step 203. If, on the other hand, the timing counter t_{Zähler} is greater than the predefined first timing threshold value, a step 211 is carried out following the step 210.

In the step 211 the friction coefficient value Fμ is determined by evaluating the frequency distribution of values and the maximum value of the velocity change value a_{xFilt}(t).

For this purpose, the percentage distribution of the slip value λ_{VA} or λ_{HA} over the individual slip classes is firstly determined. For this purpose, the sum of all the slip classes is formed and the individual slip class counters are divided by this sum. As a result, on the one hand the maximum value of the velocity change value a_{xFilt}(t) is made available, and on the other hand the percentage distribution of the slip value λ_{VA} or λ_{HA} over the individual slip classes is made available. The friction coefficient value Fμ is then determined taking into account these two parameters and using the following table.

TABLE
Percentage slip distribution for different vehicle acceleration
and deceleration values on different underlying surfaces.

| | | Slip class | | | | | | | | | | | |
|---|---|---|---|---|---|---|---|---|---|---|---|---|---|
| axfilt | | 0.5%-1% | | 1%-1.5% | | 1.5%-2% | | 2%-2.5% | | 2.5%-3% | | 3%-4% | |
| min | max | min | max | min | max | min | max | min | max | min | max | min | max |
| [m/s] | [m/s] | [%] | [%] | [%] | [%] | [%] | [%] | [%] | [%] | [%] | [%] | [%] | [%] |

Good grip (dry asphalt)

| | | | | | | | | | | | | | |
|---|---|---|---|---|---|---|---|---|---|---|---|---|---|
| −5.0 | −3.0 | a.1.1 | a.1.2 | a.1.3 | a.1.4 | a.1.5 | a.1.6 | a.1.7 | a.1.8 | a.1.9 | a.1.10 | a.1.11 | a.1.12 |
| . . . | . . . | . . . | . . . | . . . | . . . | . . . | . . . | . . . | . . . | . . . | . . . | . . . | . . . |
| 3.0 | 4.0 | a.n.1 | a.n.2 | a.n.3 | a.n.4 | a.n.5 | a.n.6 | a.n.7 | a.n.8 | a.n.9 | a.n.10 | a.n.11 | a.n.12 |

Good grip (uneven snow)

| | | | | | | | | | | | | | |
|---|---|---|---|---|---|---|---|---|---|---|---|---|---|
| 1.0 | 1.5 | b.1.1 | b.1.2 | b.1.3 | b.1.4 | b.1.5 | b.1.6 | b.1.7 | b.1.8 | b.1.9 | b.1.10 | b.1.11 | b.1.12 |
| . . . | . . . | . . . | . . . | . . . | . . . | . . . | . . . | . . . | . . . | . . . | . . . | . . . | . . . |
| 2.0 | 2.5 | b.n.1 | b.n.2 | b.n.3 | b.n.4 | b.n.5 | b.n.6 | b.n.7 | b.n.8 | b.n.9 | b.n.10 | b.n.11 | b.n.12 |

Slippery (even snow)

| | | | | | | | | | | | | | |
|---|---|---|---|---|---|---|---|---|---|---|---|---|---|
| −3.0 | −2.5 | c.1.1 | c.1.2 | c.1.3 | c.1.4 | c.1.5 | c.1.6 | c.1.7 | c.1.8 | c.1.9 | c.1.10 | c.1.11 | c.1.12 |
| . . . | . . . | . . . | . . . | . . . | . . . | . . . | . . . | . . . | . . . | . . . | . . . | . . . | . . . |
| 2.5 | 3.0 | c.n.1 | c.n.2 | c.n.3 | c.n.4 | c.n.5 | c.n.6 | c.n.7 | c.n.8 | c.n.9 | c.n.10 | c.n.11 | c.n.12 |

Slippery (antilock braking/traction control/
electronic stability program)

| | | | | | | | | | | | | | |
|---|---|---|---|---|---|---|---|---|---|---|---|---|---|
| −5.0 | 5.0 | d.1.1 | d.1.2 | d.1.3 | d.1.4 | d.1.5 | d.1.6 | d.1.7 | d.1.8 | d.1.9 | d.1.10 | d.1.11 | d.1.12 |
| −5.0 | 5.0 | d.2.1 | d.2.2 | d.2.3 | d.2.4 | d.2.5 | d.2.6 | d.2.7 | d.2.8 | d.2.9 | d.2.10 | d.2.11 | d.2.12 |

| | Slip class | | |
|---|---|---|---|
| axfilt | 4%-5% | 5%-6% | >6% |

| | | | | | | | |
|---|---|---|---|---|---|---|---|
| min | max | min | max | min | max | min | max |
| [m/s] | [m/s] | [%] | [%] | [%] | [%] | [%] | [%] |

Good grip (dry asphalt)

| | | | | | | | |
|---|---|---|---|---|---|---|---|
| −5.0 | −3.0 | a.1.13 | a.1.14 | a.1.15 | a.1.16 | a.1.17 | a.1.18 |
| . . . | . . . | . . . | . . . | . . . | . . . | . . . | . . . |
| 3.0 | 4.0 | a.n.13 | a.n.14 | a.n.15 | a.n.16 | a.n.17 | a.n.18 |

Good grip (uneven snow)

| | | | | | | | |
|---|---|---|---|---|---|---|---|
| 1.0 | 1.5 | b.1.13 | b.1.14 | b.1.15 | b.1.16 | b.1.17 | b.1.18 |
| . . . | . . . | . . . | . . . | . . . | . . . | . . . | . . . |
| 2.0 | 2.5 | b.n.13 | b.n.14 | b.n.15 | b.n.16 | b.n.17 | b.n.18 |

Slippery (even snow)

| | | | | | | | |
|---|---|---|---|---|---|---|---|
| −3.0 | −2.5 | c.1.13 | c.1.14 | c.1.15 | c.1.16 | c.1.17 | c.1.18 |
| . . . | . . . | . . . | . . . | . . . | . . . | . . . | . . . |
| 2.5 | 3.0 | c.n.13 | c.n.14 | c.n.15 | c.n.16 | c.n.17 | c.n.18 |

Slippery (antilock braking/traction control/
electronic stability program)

| | | | | | | | |
|---|---|---|---|---|---|---|---|
| −5.0 | 5.0 | d.1.13 | d.1.14 | d.1.15 | d.1.16 | d.1.17 | d.1.18 |
| −5.0 | 5.0 | d.2.13 | d.2.14 | d.2.15 | d.2.16 | d.2.17 | d.2.18 |

The above table has the following structure: the table is, apart from the header line, divided essentially into four series of rows. Two series of rows relate to conditions for an underlying surface with good grip and two series of rows relate to conditions for a slippery underlying surface. In particular, the series of rows are as follows: a first series of rows describes different conditions for a slippery underlying surface with dry asphalt; a second series of rows describes various conditions for an underlying surface with good grip for uneven snow; a third series of rows describes various conditions for a slippery underlying surface with even snow and a fourth series of rows describes driving situations in which the vehicle is located on a slippery underlying surface and at the same time brief closed-loop controller interventions of a brake slip control system (ABS) and/or of a traction control system (TCS) and/or a yaw rate control system (ESP) occur.

Each individual row which is associated with the four series of rows has the following structure corresponding to the header line of the table: in the first column which has the header “axfilt”, in each case a value range for the velocity change value a_{xFilt}(t) is given. The following relationship applies here: negative values represent deceleration of the vehicle and positive values represent acceleration of the vehicle. Using the columns which follow this column and which have the joint header “Slip class”, the value range of the axle-related slip values λ_{VA} or λ_{HA} or the wheel slip values λij which is to be expected according to experience is divided into individual slip classes. The present embodiment is based on a subdivision into nine slip classes, which is however not intended to represent any restriction. Of course, this value range can also be subdivided more finely or more coarsely.

Depending on the respectively present conditions of the underlying surface, differentiation is performed according to the abovementioned four series of rows, and the respectively present value range for the velocity change value a_{xFilt}(t) results in a distribution which is characteristic of the axle-related slip values λ_{VA} or λ_{HA} or the wheel slip values λij, this being what is referred to as a frequency distribution in which a frequency can be specified for each of the slip classes. This frequency distribution can, for example, be determined empirically using driving trials. The frequency distribution indicates how the axle-related slip values λ_{VA} or λ_{HA} or the wheel slip values λij which occur when the vehicle is driving on a slippery underlying surface or on an underlying surface with good grip are distributed usually, i.e. statistically. Since the frequency values which are determined for the individual slip classes naturally fluctuate, in each case a minimum frequency value and a maximum frequency value are specified for the individual slip classes.

The number of individual rows which are combined to form a series of rows depends on how finely the value ranges for the velocity change value a_{xFilt}(t) are subdivided.

Each individual row of the rows contained in the table uses the minimum and maximum frequency values to describe a frequency distribution for the wheel slip values λij and for the axle-related slip values λ_{VA} or λ_{HA} which is characteristic for the respective conditions of the underlying surface and the respective value range of the velocity change value a_{xFilt}(t).

The friction coefficient value Fμ and the information which is to be assigned to the friction coefficient value Fμ are determined as follows: first possible rows of the table are determined by evaluating the maximum value of the velocity change value a_{xFilt}(t). For this purpose it is checked in which of the intervals specified in this first column this maximum value is contained in. It is then determined which of these possible rows has a distribution which corresponds to the frequency distribution of values determined for the axle-related slip values λ_{VA} or λ_{HA} or to that determined for the wheel slip values λij. For this purpose, for each of the possible rows it is determined whether, for all of the slip class counters λ_{kZähler}, the percentage value which is respectively assigned to said counter is contained in the interval of the respectively associated slip class. If there is a row in which correspondence occurs for all the slip classes, this row determines the information which is to be assigned to the friction coefficient value Fμ. The friction coefficient value Fμ is, depending on the result, assigned the information “slippery” or information “good grip” or a correspondingly coded signal value as information.

If, on the basis of the procedures, above, a table hit is obtained, the state between the tire and underlying surface has been detected for the last acceleration phase or deceleration phase of the vehicle and there can be a corresponding reaction to it.

In each case a separate friction coefficient value can be determined for a plurality of successive, identical, predefined operating states of the vehicle using the procedure described above. That is to say friction coefficient values can be determined in a plurality of chronologically successive processes which are independent of one another. On the basis of this procedure it is possible to improve the method according to the invention by forming a mean value from a plurality of such friction coefficient values.

At this point details will also be given on how the table above is generated. The characteristic percentage slip class distributions for acceleration and deceleration processes were determined empirically in advance by driving trials on an underlying surface with good grip and on a slippery underlying surface and stored as a table for slippery conditions (snow cover) and for conditions with good grip (dry asphalt).

In order to extend the estimation of the coefficient of friction it is possible to extend the above table with characteristic slip distributions for additional underlying surfaces such as, for example, grit or sand and for additional conditions of an underlying surface, as an example an underlying surface which is covered with foliage or water on the underlying surface are mentioned. The table is to be correspondingly expanded with further series of rows.

Such predefined operating states of a vehicle in which a closed-loop control intervention by a brake slip controller and/or by a traction slip controller and/or by a yaw rate controller occur assume a special position in the context of the above table. If such closed-loop control interventions occur, the slip distribution is shifted in the direction of the higher slip classes. For this reason, the above table has two corresponding rows which are the two rows of the fourth series of rows because in such an operating state the coefficient of friction can be detected particularly easily and unambiguously since the frequency distributions of the values of the wheel slip values λij or of the axle-related slip values λ_{VA} or λ_{HA} form a particularly high proportion of the slip classes with a high slip value. In order to detect whether there is an operating state in which a closed-loop control intervention is performed by a brake slip controller and/or by a traction slip controller and/or by a yaw rate controller, it is possible to evaluate corresponding flags which indicate whether these controllers are active, or to output corresponding signals for carrying out such closed-loop control interventions. For reasons of clarity, corresponding signals have not been represented in FIG. 1.

Following step 211, a step 212 is carried out in which the further processing of the friction coefficient value Fμ takes place. First and foremost the information of the friction coefficient value Fμ is presented to the driver using the display device 105 illustrated in FIG. 1. That is to say the driver is informed whether the road which is currently being driven on has a surface with good grip or a slippery surface. Furthermore, the friction coefficient value Fμ can be fed for further processing to other closed-loop and/or open-loop control devices 106 which are arranged in the vehicle. The system jumps back from the step 212 to the step 202.

If it is detected in step 207 that the absolute value of the velocity change value a_{xFilt}(t) is smaller than the predefined threshold value, the step 213 which has already been mentioned is carried out following the step 207. In this step 213, by means of an interrogation it is checked, whether the value of the timing counter t_{Zähler} is greater than a predefined second time threshold value which corresponds, for example, to a time period of 0.5 seconds. If this is not the case, the system jumps back from the step 213 to the step 202. If, on the other hand, the timing counter t_{Zähler} is greater than the second time threshold value, the step 213 is carried out following the step 211.

The two time interrogations which are carried out in the steps 210 and 213 by evaluating the time counter t_{Zähler} have the following background: the time interrogation of the step 213 is intended to ensure that the friction coefficient value Fμ is not carried out until the predefined operating state of the vehicle has been present for a predefined minimum period and such a large number of wheel slip values λij has thus been determined that the determination of the friction coefficient value Fμ can be considered to be reliable. The time interrogation contained in step 210 has the function of ending the determination of the friction coefficient value Fμ when a predefined time period whose value can be set, for example, at 10 seconds, is reached or exceeded. The background for this is that starting from a specific time period such a large number of wheel slip values λij have been determined that additionally determining further wheel slip values λij would not provide any improvement in the quality of the determination of the friction coefficient value Fu.

As has already been indicated with respect to FIG. 1, further values can be fed to the block 101 in order to improve the determination of the friction coefficient value F. These are, for example, a value T_{auβen} which describes the outside temperature and a value F_{Scheibenwischer} which represents the operation of the windshield wiper. If these two variables are available to the block 101 as input variables, two optional steps are to be interposed between the step 201 and the step 202 in the method according to the invention. For the sake of clarity, these two optional steps have not been illustrated in FIG. 2.

In a first optional step it is possible to check, by evaluating the value T_{auβen} which describes the outside temperature whether the outside temperature is higher than a predefined temperature threshold value which represents, for example, an outside temperature of 15 degrees Celsius. If this is the case, it is possible to assume that an underlying surface with good grip is present. In this case, it is possible to dispense with processing the steps 202 to 213, and the parameter Fu can be directly assigned a value which represents an underlying surface with good grip.

As an alternative and/or in addition to this first optional step it is possible to insert a second optional step. In this second optional step it is possible to check, by evaluating the parameter T_{auβen} which describes the outside temperature and the parameter F_{Scheibenwischer} which represents the operation of the windshield wiper, whether a low outside temperature is present and at the same time the windshield wiper is operating. If this is the case, i.e. precipitation is falling and at the same time the temperature is low, it is possible to assume that conditions of the underlying surface with a low coefficient of friction are present. In this case it is also possible to dispense with the processing of steps 202 to 213, and the parameter Fμ can be directly assigned a value which represents a slippery underlying surface.

At this point the core of the method according to the invention according to the first embodiment will be summarized once more: in this method according to the invention, use is made of the fact that the tire slip behavior is typically different for an underlying surface with good grip from that for a slippery underlying surface. The connection which is represented in a μ slip curve is thus utilized. The slip behavior is determined during a predefined operating state of the vehicle. This predefined operating state of the vehicle is straight-ahead travel which takes place during an acceleration phase or deceleration phase of the vehicle. It is thus an operating state of the vehicle which is defined by a velocity change value. Basically, the axle-related slip values λ_{VA} or λ_{HA} are determined during an acceleration phase or deceleration phase of |a_{xFilt}|>0.5 m/s² and a minimum time of 0.5 s as well as a maximum time of 10 s. During this time, the slip value is calculated in each cycle, classified and the number of times it occurs is stored in the corresponding slip class and the maximum acceleration value or deceleration value is determined during the acceleration phase or deceleration phase. After the end of the acceleration phase or deceleration phase the absolute number of times which the slip values occur is calculated as a percentage distribution of the slip values over the slip classes. The values which are determined, i.e. the percentage values of the slip classes and the maximum acceleration value or deceleration value is then checked to determine whether they lie inside a specific range. For the individual slip classes and for the determined acceleration or deceleration there is in each case a range which is uniquely defined by means of a minimum permissible value and a maximum permissible value. A table hit is found if all the range conditions of a table line are fulfilled. After each slip observation phase, the table is run through completely, as a result of which multiple table hits are also possible.

A second embodiment of the device according to the invention or the method according to the invention will be described starting with FIG. 3. If, in this context, a block or step of the second embodiment corresponds to a block or step of the first embodiment, this is commented on below. The statements relating to the block or step of the first embodiment also apply in this case to the block or step of the second embodiment. The same will also apply in the other direction.

FIG. 3 shows a second embodiment of the device according to the invention in an overview, with a block 301 representing the core of this device. The specific structure of this block will be explained in more detail with reference to FIG. 4.

In order to carry out the method according to the invention, various input variables are fed to the block 301. Wheel speed values nij, which describe the wheel speeds of the individual vehicle wheels, are fed from a block 302 to the block 301. In this context, the block 302 comprises wheel speed sensors which are assigned to the individual vehicle wheels. Of course, the procedure of the first embodiment is also conceivable so that the wheel speed values nij are not fed to the block 301 but instead wheel r.p.m values vij. In this case, the block 302 would correspond to the block 102. A yaw rate value \dot{ψ}_{fil}, which describes the filtered yaw rate, is fed from the block 303 to the block 301. The block 303 corresponds to the block 103.

A lateral acceleration value ay, which describes the lateral acceleration of the vehicle, is fed from the block 304 to the block 301. Both the block 304 and the feeding of the lateral acceleration value ay are represented by dashed lines, which has the following significance: the lateral acceleration value ay is not necessarily required to carry out the method according to the invention. Whether the lateral acceleration value ay is required depends on what type of bend detection is implemented, details of this are given in conjunction with block 407.

In addition, a signal BLS which is generated by a brake light switch 305 is fed to the block 301. This is a logic signal which assumes, for example, the state TRUE if the brake light switch is switched and thus the brake pedal is being activated, and which assumes the value FALSE if the brake light switch is not switched and the brake pedal is thus not being activated. Moreover, the brake light switch 305 corresponds to the brake light switch 104.

A value FEAAZ which contains the information about the state of closed-loop and/or open-loop control devices contained in the vehicle is fed from a block 306 to the block 301. That is to say this value contains information indicating whether one of these closed-loop and/or open-loop control devices is active and is carrying out a closed-loop and/or open-loop control intervention, and if so which. These devices may be, for example, brake slip control devices and/or traction slip control devices and/or yaw rate control devices of the vehicle.

The variable FEAAZ has in this context a different information content depending on which of the devices mentioned above is active. If, for example, the brake slip control device is active, the variable FEAAZ contains, for each vehicle wheel, information indicating whether or not brake slip is occurring at this vehicle wheel. If the traction slip control device is active, the variable FEAAZ contains, for each vehicle wheel, information indicating whether or not drive slip is occurring at this vehicle wheel. In both cases, the information is made available on a wheel-specific basis for the following reason: both in the case of an intervention in order to control brake slip and in the case of an intervention for traction slip control, high brake slip values or drive slip values occur at individual vehicle wheels for a relatively long time period. During the determination of the frequency distribution of values this leads to a shifting of the frequency distributions of values which have been determined on a wheel-specific basis in the direction of slip values which are large in absolute terms. In order to be able to interpret correctly such shifted frequency distributions the information as to which wheel a brake slip or drive slip is occurring at is evaluated. In addition, in such a situation plausibility checking can be carried out on the determined friction coefficient values by estimating the transmitted force which constitutes a measure of the coefficient of friction which is being utilized and is thus actually present. This is because the frequency distribution of values which exhibits a high wheel slip could give the impression that a slippery underlying surface is present. If it becomes apparent during the estimation of the transmitted force that an excessively high coefficient of friction is present, a slippery underlying surface cannot be present and instead an underlying surface with good grip must be present. Details will be given below.

If, in contrast, the device for controlling the yaw rate of the vehicle is active, the parameter FEAAZ merely contains a global information indicating whether or not a braking intervention is carried out at one of the vehicle wheels. This global information is sufficient for the following reason: a braking intervention which is carried out within the scope of the control of the yaw rate brings about a yaw torque which acts on the vehicle in order to stabilize a state of the vehicle which is unstable in terms of lateral dynamics and during which considerable lateral slip values may occur. Since the present method according to the invention for determining the friction coefficient value is based on the evaluation of the longitudinal slip which is present at the individual vehicle wheels, taking into account such driving situations during the determination of the frequency distribution of values would lead to a falsification of the result, i.e. to a falsification of the determined friction coefficient value. For this reason, if the variable FEAAZ indicates that a braking intervention of a device for controlling the yaw rate is occurring, the determination of the frequency distribution of values is interrupted for the period of time during which this intervention is occurring. At the same time, in such driving situations the outputting of the snowflake symbol is dispensed with. Details will be given below.

A variable T_{auβen} which describes the outside temperature is fed to the block 301 from a block 307, which is for example a temperature sensor and corresponds to the block 107. Furthermore, a parameter F_{Regen} can optionally be fed to the block 301, this being indicated by the dashed representation, from a block 308 which is, for example, a rain sensor. This variable informs the block 301 whether water, for example from precipitation or from a wet underlying surface (spray water), is located on the windshield. As an alternative or in addition to this, by means of this variable the block 301 can be provided with information about the wiping activity of the windshield wiper. This information may comprise, for example, the number of wiping processes per time unit.

Furthermore, a variable F_{Scheibenwischer} which represents the operating state of the windshield wiper can optionally be fed to the block 301, this being indicated by the dashed representation, from a block 309 which corresponds to the block 108. The variable F_{Scheibenwischer} can contain various information items. For example information as to whether the windshield wiper is in the interval operating mode, and in conjunction with a rain sensor interval wiping with a variable interval length is obtained, and/or information as to whether the windshield wiper is outside its parked position, i.e. whether the windshield wiper is currently moving, and/or information as to whether the driver has activated the wash wipe function in order to clean a dirty windscreen, and in this case, owing to the activity of the windshield wiper, it is not necessarily possible to conclude that the underlying surface is wet and thus slippery.

In block 301, the method according to the invention of the second embodiment runs by processing the input variables fed to it. With this method according to the invention, a friction coefficient value Fμ which represents the coefficient of friction present between the underlying surface and the vehicle tire is determined. As in the first embodiment, a measure is determined which represents the conditions of the road in a qualitative fashion, in the form of a differentiation as to whether the underlying surface has good grip or is slippery.

Starting from block 301, the friction coefficient value Fμ is fed both to a block 310 and to a block 311. In this context, the illustration selected in FIG. 3 is not intended to be restrictive to the effect that only a single value is fed to these two blocks. Instead, this representation is also intended to include the possibility that the friction coefficient value Fμ contains both a component which is intended for the block 310 and a component which is intended for the block 311, and as a result a separate value is fed both to the block 310 and to the block 311. The block 310 is a warning system which has already been described in conjunction with the first embodiment and which indicates hazardous locations in the course of the road to the driver using a display device by including road signs which symbolize hazardous locations in the display. The display device is represented in FIG. 3 by a block 311 which corresponds to the block 105.

The friction coefficient value Fμ is used to inform the warning system 310 of the class of coefficient of friction which has been determined, i.e. whether the underlying surface is slippery or has good grip. In this context, the friction coefficient value Fμ can assume in particular the following states and thus contain the following information: there is no coefficient of friction information available and this state is assumed in particular when initializing the determination of the coefficient of friction; a high coefficient of friction is present and thus an underlying surface with good grip is present; a low coefficient of friction is present and thus a slippery or wet underlying surface is present.

The information which is conveyed to the warning system 310 by means of the friction coefficient value Fμ influences the method of operation of the warning system. For example, this information is used for switching over characteristic curves or for accessing, i.e. selecting, parameters or characteristic diagrams which are dependent on the coefficient of friction. As a result, in the case of a warning system in which a warning is issued only if the velocity of the vehicle exceeds a velocity threshold value corresponding to the hazardous location, the velocity threshold value which gives rise to driver information can be reduced in road conditions with a low coefficient of friction and the driver can thus be informed earlier. In a warning system in which the information is included in the display and thus the driver is warned independently of the velocity of the vehicle, this information can be issued earlier when the underlying surface is slippery, i.e. when there is a low coefficient of friction. Overall, the driver is thus warned earlier with both embodiments of the warning system.

As already mentioned, the block 311 is a display device which is contained in the warning system. The information which is conveyed to the display device 311 using the friction coefficient value Fμ triggers the display of a warning symbol which may be, for example, a snowflake and with which the driver is to be made aware of the presence of a low coefficient of friction and thus of a slippery underlying surface. For this purpose, one possibility is for the same information to be made available to the display device 311 as to the warning system 310, i.e. information about the class of coefficient of friction which is determined. Alternatively, merely a request to display the warning symbol can be fed in. As a further alternative, it is possible for no variable or no signal to be fed to the display device 311. In this case, the display device 311 is actuated by variables which are generated internally in the warning system 310.

The method of operation of the block 301 will be described in more detail below with reference to a FIG. 4. A block 401 is used to determine wheel r.p.m values vij on the basis of the wheel speed values nij fed to it. For this purpose, the wheel speeds are converted into wheel r.p.m values using a value for the circumference of the wheel. The wheel r.p.m values which are determined in this way are then filtered and output to a block 402 and a block 403 as wheel r.p.m values vij. If, as has already been described in conjunction with FIG. 3, the wheel r.p.m values vij are fed to the block 301 instead of the wheel speed values nij, the block 401 is not necessary in this way. In this case, the functions of the block 401 are contained in the block 302.

In the block 402, a velocity value vref which describes the vehicle reference velocity is determined as a function of the wheel r.p.m value vij which are fed to it. During the determination of the velocity value vref, a differentiation is made between a case of braking and a case of driving or freewheeling as in the first embodiment. This differentiation is carried out by means of the signal BLS which is fed to the block 402, with the following relationship applying to the signal BLS: when the brake light switch is activated, a case of braking is occurring, and when a brake light switch is not activated, a case of driving or freewheeling is occurring. If the case of braking occurs, the vehicle wheel with the highest wheel r.p.m is firstly determined. The velocity value vref is determined from this wheel r.p.m by means of filtering. In this context, the filtering is intended to limit the velocity value vref which is to be determined. If, on the other hand, the case of driving occurs, the velocity value of vref is determined by forming the mean value of the wheel r.p.m values of the two non driven wheels; in the case of a vehicle with rear wheel drive this is thus determined from the wheel r.p.m values of the two front wheels. During the determination of the velocity value vref a limitation is advantageously carried out in such a way that the change in the velocity value over time for two successive cycle times is limited to a maximum value. The velocity value vref is fed to a block 403, a block 406, a block 409 and optionally to a block 407, represented by the dashed line.

In the block 403, wheel slip values λij for the vehicle wheels are determined in the block 403 as a function of the wheel r.p.m value vij which are fed to it and the velocity value vref. During the determination of the wheel slip values λij, a differentiation is made between a case of braking and a case of driving using the signal BLS which is also fed to the block 403. If a case of braking occurs, the wheel slip values λij are determined according to the relationship
λij=(vij−vref)/vref.

If, on the other hand, the case of driving occurs, the wheel slip values λij are determined according to the relationship
λij=(vij−vref)/vij.

The wheel slip values λij are fed for further processing to a block 404 which is to be described below. In the block 406, stationary state detection is carried out by evaluating the velocity value vref which is fed to it. For this purpose, the velocity value vref is compared with a predefined threshold value which is, for example, of the order of magnitude of 3 m/s. The result of this evaluation is fed to a block 408, to be described below, using a variable FStill which corresponds to a logic variable. For example the following relationship applies to the variable FStill: if the velocity value vref drops below the threshold value, it is possible to assume that the vehicle is virtually stationary or stationary, for which reason the variable FStill is assigned the value TRUE. If, on the other hand, it is detected that the velocity value vref is greater than the threshold value, it is detected that the vehicle is driving and the variable FStill is assigned the value FALSE. The variable FStill thus contains information as to whether the vehicle is virtually stationary or whether the vehicle is stationary.

In a block 407, cornering detection is carried out by evaluating the variables which are fed to it. The result of the cornering detection is fed to the block 408 using a variable FKurve which corresponds to a logic variable. The variable FKurve thus contains information as to whether or not the vehicle is cornering, or whether or not the vehicle is traveling through a bend. There are two alternative embodiments for carrying out the detection of cornering. In a first embodiment, the lateral acceleration value ay and the yaw rate value \dot{ψ}_{fil} are evaluated in order to detect cornering. In this first embodiment, cornering is occurring if at least one of the two above parameters exceeds a respectively associated threshold value. In this case, the parameter FKurve is assigned the value TRUE. If, on the other hand, it is detected that both the lateral acceleration value ay and the yaw rate value \dot{ψ}_{fil} are below the respectively associated threshold value, straight-ahead travel is detected. In this case, the value FALSE is assigned to the variable FKurve. The threshold value for the lateral acceleration is, for example, of the order of magnitude of 2 m/sˆ2. The threshold value for the yaw rate is, for example, of the order of magnitude of 10°/s. In a second embodiment, the yaw rate value \dot{ψ}_{fil} and the velocity value vref are evaluated in order to detect cornering. For this purpose, the following relation in which a quotient which is formed as a function of the yaw angle value \dot{ψ}_{fil} and the velocity value vref taking into account the wheel track of the vehicle FzgSpurbreite is compared with a threshold value S1 is evaluated:

$$\frac{\vert {\dot{Ψ}}_{fil} \vert \cdot FzgSpurbreite}{2 \cdot vref} > S 1.$$

In this embodiment, cornering is occurring if the above relation is fulfilled, i.e. if the aforesaid quotient is greater than the threshold value S1 and the velocity value vref is greater than an associated threshold value which has, for example, the value zero. In this case, the value TRUE is assigned to the parameter FKurve. Otherwise, cornering does not occur, for which reason the parameter FKurve is assigned the value FALSE.

In the above relation, the quotient represents a measure of the radius of the bend which the vehicle is traveling through. The threshold value S1 corresponds to a multiple of the interval length of the slip classes into which the respective slip range on which the frequency distribution of values is based is subdivided. The quotient is therefore compared with a multiple of the interval length since distinct cornering, such as occurs, for example, during a turning maneuver, gives rise to different wheel slip values on the two sides of the vehicle, which becomes distinct through shifting of the frequency distribution of values for the left-hand and right-hand vehicle wheels. The threshold value S1 is thus a measure of the shifting of the frequency distribution of values which occurs owing to cornering.

The alternative embodiment of the means of detecting cornering is indicated in FIG. 4 in that the feeding of both the velocity value vref and of the lateral acceleration value ay to the block 407 is represented by dashed lines.

In the block 408 which has already been mentioned, the variables FStill and FKurve which are fed to the block are used to detect whether a predefined operating state of the vehicle in which the frequency distribution of values is being determined is present. The result of this evaluation is output by the block 408 using a variable FKlass. If it is detected during the evaluation of the two variables FStill and FKurve that at least one of these two variables has the value TRUE, the determination of the frequency distribution of values is not carried out. In other words, if the vehicle is virtually in the stationary state or if the vehicle is traveling through a bend, in particular a distinct bend, the frequency distribution of values is not determined. In this case, for example the value FALSE is assigned to the parameter FKlass. Otherwise this signifies that if the vehicle is neither virtually in the stationary state nor traveling through a bend, the frequency distribution of values is determined. Formulated in a different way: the frequency distribution of values is carried out during travel at a certain minimum velocity essentially in a straight line. In this case, for example the value TRUE is assigned to the variable FKlass. Driving situations in which the vehicle is virtually in a stationary state or is traveling through a distinct bend are therefore gated out because, as far as the wheel slip is concerned, they are highly dynamic processes in which determination of the friction coefficient value by evaluating a frequency distribution of values does not supply any reliable, i.e. usable, results.

The result of the evaluation which is carried out in block 408 is fed to one of the three blocks 403 or 404 or 405. This is indicated in FIG. 4 by feeding the variable FKlass to a block formed from dashed lines in which the three blocks 403, 404 and 410 are included. This makes it possible to influence the operating sequence of at least one of these three blocks and thus to intervene in various ways in the determination or evaluation of the frequency distribution of values or to prevent said determination or evaluation.

In the block 404 which has already been mentioned, the wheel slip values λij which have been fed to it are classified, i.e. the frequency distribution of values of the wheel slip values λij is determined. The result of this classification, i.e. the frequency distributions of values determined for the individual vehicle wheels are fed in the form of the values λktabij to the block 405 which has already been mentioned. In the block 405, the frequency distributions of values which have been fed to it for the individual vehicle wheels are evaluated, as a result of which a wheel friction coefficient value Fμji is determined for each of the vehicle wheels. The result of this evaluation is fed for further processing to a block 411, to be described below, in the form of the friction coefficient values Fμij. The operational sequences taking place in blocks 404, 405 and 411 will be described in detail in conjunction with FIG. 5. The parameter FEAAZ is fed to the dashed line block in which the three blocks 403, 404 and 405 are included. If this parameter indicates that a braking intervention of the device for performing closed-loop control of the yaw rate is occurring, the determination of the frequency distribution of values which takes place in the block 404 is gated out for as long as the aforesaid braking intervention lasts. As an alternative, the evaluation which takes place in the block 405 can also be eliminated.

In the block 409 which has already been mentioned, a longitudinal acceleration variable ax which describes the acceleration of the vehicle is determined as a function of the velocity value vref fed to it. This longitudinal acceleration variable ax may be acquired, for example, by forming a derivative over time or by suitable filtering. The longitudinal acceleration variable ax is fed to a block 410.

The transmission force is estimated in the block 410. Formulated in general terms during this estimation the acceleration which acts on the vehicle, in particular the longitudinal acceleration which acts on the vehicle, is placed in a relationship with the gravitation constant, permitting a measure of the coefficient of friction which is utilized in the respective driving situation to be determined. In terms of the specific implementation of this estimation of the transmission force, two configurations are conceivable. In a first configuration, two driving states of the vehicle, the case of braking and the case of driving or freewheeling, are distinguished when estimating the transmission force using the signal BLS which is fed to the block 410. In the case of braking, the estimated value is obtained for the coefficient of friction both for the front axis and for the rear axis from the present, real acceleration or deceleration of the vehicle, the gravitation constant g and a variable MUE_ROLL which represents the rolling resistance value of an average asphalt roadway. The estimated value for the coefficient of friction is obtained, for example, in accordance with the relationship
μPlausVA=μPlausHA=|ax|/(g*MUE_ROLL).

In the case of driving or freewheeling, a differentiation is made between the front axle and the rear axle when the transmission of force is being estimated. For the front axle, the estimated value μPlausVA for the coefficient of friction corresponds to the value MUE_ROLL, while the estimated value μPlausHA for the coefficient of friction at the rear axle is obtained in accordance with a relationship
μPlausHA=(F_{Luft}+F_{Roll}+F_{Antrieb})/(a*m*g).

That is to say the longitudinal acceleration which acts on the vehicle is placed in a relationship with the gravitation constant g, with the proportion which acts on the rear axle as a result of the structurally conditioned distribution of axle load being taken into account by the factor a. The determination of the acceleration which acts on the vehicle includes, for example, the acceleration of the vehicle which is present in the respective driving situation and originates from an engine intervention, or the deceleration of the vehicle which originates from the braking intervention as well as a deceleration component which originates from the air resistance and/or the rolling resistance. The two variables μPlausVA and μPlausHA are fed to the block 411.

In a second embodiment, it is proposed that the transmission of force be estimated and this is carried out with a smaller degree of computational complexity. In the second embodiment, a differentiation is not made between a case of braking and a case of driving, and neither are the front axle and rear axle considered separately. In this case, the transmission of force is estimated using, for example, the following quotient:
μPlaus=(F_{Luft}+F_{Roll}+F_{Antrieb})/(m*g)

with the variable μPlaus constituting the measure of the coefficient of friction which is utilized in the present driving situation. The variable μPlaus is fed from the block 410 to the block 411. Since this second embodiment is less precise than the first embodiment, the second embodiment is merely mentioned here while no further details are given on it later on. For this reason, the variable μPlaus has not been entered in FIG. 4 either.

In addition to the variables μPlausVA and μPlausHA, further variables are fed to the block 411. These are the variables FEAAZ and T_{auβen} which have already been described in conjunction with FIG. 3 as well as the variables F_{Regen} and F_{Scheibenwischer} which are optionally fed in. Furthermore, the signal BLS is fed to the block 411. In block 411, the friction coefficient values Fμij are checked for plausibility using the variables mentioned above and the friction coefficient value Fμ is determined on the basis of the result which is obtained in the process. Further conditions which are taken into account, for example, as a function of the distance covered by the vehicle or over the period of time for which a predefined state is present can be taken into account during this plausibility checking.

The method according to the invention which runs in the block 301 of the second embodiment of the device according to the invention is described below with the aid of FIG. 5. In particular, details are given here on the method of operation of blocks 404, 405 and 411. This method according to the invention starts with a step 501 which is followed by a step 502 in which different variables are initialized. On the one hand, slip class counters λktabij which are to be described later are initialized. On the other hand, an intermediate value Fμ_Plaus and the wheel friction coefficient values Fμij and the friction coefficient value Fμ are initialized. Both the intermediate value Fμ_Plaus and the wheel friction coefficient values Fμij and the friction coefficient value Fμ are each assigned values which stand for the fact that at present no friction coefficient information is available. If the friction coefficient value Fμ contains both a component which is intended for the block 310 and a component which is intended for the block 311, these two components are also initialized in accordance with the statements relating to the friction coefficient value Fμ.

The step 502 is followed by a step 503 in which the input variables which are to be fed to the block 301 are made available. In particular these are the wheel speed values nij, the yaw rate value \dot{ψ}_{fil}, the optionally processed lateral acceleration value ay, the signal BLS, the variable FEAAZ, the variable T_{auβen} and the two optionally processed variables F_{Regen} and F_{Scheibenwischer}. In this context it is possible to provide for the variables T_{auβen}, F_{Regen} and F_{Scheibenwischer} not to be present in an updated form whenever the step 503 is run through but rather for an updated value to be made available only at each tenth pass, for example. This is justified since the external temperature, for example, changes only slowly.

Different variables are determined in a following step 504. These are the wheel r.p.m values vij determined in block 401, the velocity value vref determined in block 402, the variable FStill determined in block 406, the variable FKurve determined in block 407 and the longitudinal acceleration variable ax determined in block 409. The wheel slip values λij are determined in a step 505 which follows the step 504.

The step 505 is followed by a step 506 in which it is determined whether the predefined operating state of the vehicle is present. For this purpose, the evaluation of the two variables FStill and FKurve described in conjunction with the block 408 is carried out. If it is detected in step 506 that the vehicle is in the predefined operating state, in this case the vehicle is traveling at a minimum velocity essentially in a straight line, for which reason the frequency distribution of values for the wheel slip values λij can be determined and a step 507 is thus carried out following the step 506. If, in contrast, it is detected in the step 506 that the predefined operating state of the vehicle is not present, in this case the vehicle is virtually in the stationary state or the vehicle is traveling through a bend, in particular a distinct bend, the frequency distribution of values for the wheel slip values λij cannot be determined, for which reason the step 503 is carried out again after the step 506. The branching operation which is carried out using the step 506 ensures that the frequency distribution of values is not carried out as long as the predefined operating state of the vehicle is not present, but the variables which are required for this, in particular the wheel slip values λij are nevertheless made available.

As an alternative to the sequence of the two steps 505 and 506 which is represented in FIG. 5, the step 505 can also follow the step 506. This would mean that the wheel slip values λij are determined exclusively when the predefined operating state of the vehicle is present. Whereas on the basis of the arrangement of the two steps 505 and 506 shown in FIG. 5 the wheel slip values λij are determined both when the predefined operating state of the vehicle is present and when it is not present.

In the step 507 which has already been mentioned, the frequency distribution of values of the wheel slip values λij are determined. In this context, separate frequency distribution of values for the associated wheel slip value λij is determined for each of the vehicle wheels. In driving trials, a slip range which is to be considered and which is described by a minimum slip value and a maximum value is determined. This slip range is used as a basis for determining the frequency distribution of values. It is subdivided into a predefined number of slip classes which advantageously have an equidistant width, i.e. identical interval length. It is also conceivable to adapt the interval length of the individual slip classes to the anticipated structure of the frequency distribution of values, and to permit narrower slip classes in certain ranges and wider slip classes in certain ranges, as is indicated, for example, in the first embodiment. The slip classes are advantageously arranged symmetrically with respect to the “zero” slip value. The slip class which includes the minimum slip value, or which follows it directly, is referred to as the first slip class. The slip class which includes the maximum slip value, or which follows it directly, is referred to as the last slip class.

As is apparent from the illustration in FIG. 5, the method is a cyclical method. In this context the steps 503 to 509 are to be run through once per cycle time which is, for example, of the order of magnitude of 10 to 100 milliseconds. As a result, wheel slip values λij which are sorted into the predefined slip classes in order to determine the frequency distribution of values are present every 10 to 100 milliseconds. If the predefined operating state of the vehicle is present, the frequency distribution of values is updated and evaluated in each cycle time. The frequency distribution of values is advantageously determined for each of the vehicle wheels, which means that the classification of the corresponding wheel slip value is carried out for each of the vehicle wheels.

The frequency distribution of values is determined using the already mentioned slip class counters λktabij, with a separate slip class counter being provided for each of the vehicle wheels. The slip class counters are advantageously multidimensional values, referred to as vector values, which have a number of counter elements which corresponds to the number of slip classes. Each individual counter element thus represents the frequency of occurrence of the value of the wheel slip value in the associated slip class, while the slip class counter per se represents the frequency distribution of the values of the wheel slip values in the entire slip range.

During the subsequent description of the procedure on which the determination of the frequency distribution of values is based, any desired time is considered together with the wheel slip value which is present at this time. If the value of the determined wheel slip value lies within the slip range which is defined by the minimum and the maximum slip values, it is determined which slip class the wheel slip value lies in. For this purpose, the wheel slip value is compared with the two range limits of the slip classes. The counter element of the slip class counter which is associated with the slip class within whose range limits the wheel slip value lies is incremented. As a result, the wheel slip value which is placed in the respective slip class brings about a change in value of the frequency of occurrence in this slip class, said frequency being represented by the counter element. If it is detected during the comparison of the wheel slip value with the maximum and the minimum slip values that the value of the wheel slip value is lower than the minimum slip value, the counter element which is associated with the first slip class is incremented. If it is detected during this comparison that the value of the wheel slip value is greater than the maximum slip value, the counter element which is associated with the last slip class is incremented.

As already mentioned, the determination of the friction coefficient value according to the invention is a cyclical method. For this reason, suitable standardization is necessary when determining the individual frequencies of occurrence and thus when determining the frequency distribution of values since the sum of all the frequencies of occurrence, i.e. the sum of the values of the counter elements of one slip class counter, must always result in 100%.

When the frequency of occurrence of a slip class is updated, such updating being necessary when the value of the wheel slip value lies within this slip class, the value of the old frequency of occurrence, i.e. the value which occurred before the updating process, is advantageously weighted to a greater extent than the newly added value.

In the step 508 which follows the step 507, wheel friction coefficient values Fμij are determined for the individual vehicle wheels. The procedure which is used as a basis here will be described with reference to FIGS. 6a, 6c and 6c, and even though only one of the vehicle wheels will be considered the procedure is identical for all the vehicle wheels.

FIG. 6a shows a frequency distribution of values which is obtained by the classification of the wheel slip values which is determined for one vehicle wheel, said distribution being characteristic of the coefficient of friction pairing of the wheel/road. In FIG. 6a, the slip classes are plotted on the abscissa starting with the first slip class and ending with the last slip class. On the ordinate, the frequencies h of the individual slip classes, which are also referred to as frequencies of occurrence, are plotted. The entire diagram which is illustrated in FIG. 6a represents the frequency distribution of values for the associated wheel slip value which is determined for one vehicle wheel.

The determination of the wheel friction coefficient value Fμij is carried out as follows for each of the vehicle wheels: first, the slip class with the greatest frequency, i.e. with the greatest frequency of occurrence of all the slip classes is determined. Then, starting from the first slip class and going in the direction of the slip class with the greatest frequency of occurrence, that slip class g1 which is the first whose frequency of occurrence is greater than a predefined value MUE_HÄUFIGKEIT_MIN is determined. The mean slip value λg1 is determined for this slip class g1. In a corresponding way, starting from the last slip class and going in the direction of the slip class with the greatest frequency of occurrence, that slip class g2 which is the first whose frequency of occurrence is greater than the predefined value MUE_HÄUFIGKEIT_MIN is determined. The mean slip value λg2 is also determined for this slip class g2.

In a subsequent step, starting from the two slip classes g1 and g2 the variance g of the wheel slip value according to the following relationship is determined:
g=λg2−λg1.

According to the statements above, the slip classes must have a minimum frequency of occurrence which corresponds to the predefined value MUE_HÄUFIGKEIT_MIN so that these slip classes are taken into account during the determination of the variation in slip which is described by the variance g.

The pattern of the wheel slip value, i.e. the frequency distribution of values can be described or characterized using the two variables of the variance g and greatest frequency of occurrence, and it is thus possible to make a decision as to whether the underlying surface has good grip or is slippery. Specifically the frequency of distribution of values is narrow and high when the underlying surface has good grip while it is wide and flat when the underlying surface is slippery.

The differentiation as to whether the underlying surface has good grip or is slippery is performed by means of a boundary line which fulfils the function of a decision criterion. FIG. 6b shows a first boundary line. FIG. 6b shows a coordinate system on whose abscissa the variance g is plotted and on whose ordinate the maximum frequency of occurrence is plotted, this being a parabolic boundary line which is described by a function equation of the form
h_{GRenzlinie}=P1*gˆ+P2*g+P3.

If the value pair which is composed of the variance g and the maximum frequency of distribution lies above this parabolic boundary line, it is decided that the underlying surface has good grip. If, in contrast, the value pair lies below the boundary line, it is decided that the underlying surface is slippery. As a result, by comparing the determined value pair with the values which are predefined by the boundary line it is possible to determine a wheel friction coefficient value Fμji for each of the vehicle wheels.

A boundary line which is an alternative to the boundary line illustrated in FIG. 6b is shown in FIG. 6c. This boundary line is defined in different parts by a plurality of linear components. The illustrated boundary line has four linear components which are predefined by five reference points. This is not intended to constitute any restriction. Of course, it is also possible to use boundary lines with numerically more or fewer reference points. It is also possible to use other functions as linear components for the approximation of a curve profile which is predefined by the reference points in order to connect the reference points to one another. The second boundary line has, compared to the first boundary line, the advantage that the computational complexity required for the evaluation is less. The classification according to which an underlying surface with good grip can be assumed for value pairs above the boundary line and a slippery underlying surface can be assumed for value pairs below the boundary line also applies to the second boundary line.

To summarize: the wheel friction coefficient values Fμij are determined as a function of a first variable, specifically the variance g, which describes the wheel-slip-related variance of the frequency distribution of values determined for the respective wheel slip value λij, and a second variable which corresponds to the maximum frequency of occurrence of all the slip classes associated with the frequency distribution of values. The value of the wheel friction coefficient values Fμij is finally determined by comparing the values of the first and second variables with value pairs which are predefined for conditions of an underlying surface with good grip and conditions for a slippery underlying surface.

The procedure described above for the determination of the wheel friction coefficient values Fμij can be advantageously supplemented as follows; in this context, it should be possible to use this advantageous supplementation both for an evaluation which is based on the first boundary line and an evaluation which is based on the second boundary line. The mean slip value is determined for the slip class with the maximum frequency of distribution. This mean slip value is taken into account in the determination of the wheel friction coefficient values Fμij, which leads to a situation in which, in addition to the comparison of the value pair which is composed of the variance and the maximum frequency of occurrence, the boundary line makes available a further condition for the evaluation as to whether an underlying surface with good grip or a slippery underlying surface is present. In this case, an underlying surface with good grip is detected and a corresponding value is assigned to the wheel friction coefficient value Fμij if the value pair which is determined lies above the boundary line and the mean slip value mentioned above is less than a threshold value which represents the wheel slip conditions when a traction control system is active, and the mean slip value mentioned above is greater than a threshold value which represents the wheel slip conditions when a brake slip control system is active. If all three conditions mentioned above are not fulfilled, the underlying surface is slippery and a corresponding value is assigned to the wheel friction coefficient value Fμij.

At this point, details will be given once more on the frequency distribution of values illustrated in FIG. 6a. The form of this frequency distribution shows that these frequency distributions are, as it were, arranged according to a Gaussian distribution. Accordingly, the variance variable has the character of a standard deviation. If the method according to the invention is implemented in a control unit which has a powerful processor or computer, it is alternatively possible to determine and evaluate the standard distribution, instead of the variance. These and possibly further measures would permit a method to be implemented with which it is possible, by evaluating a frequency distribution of values, to determine a friction coefficient value which provides not only definitive qualitative information but also definitive quantitative information about the state of the underlying surface.

In a step 509 which follows the step 508, the friction coefficient value Fμ is determined. For this purpose, an intermediate value Fμ_Plaus is firstly determined by evaluating the variables and signals fed to the block 411. This is done using various plausibility interrogations which are stored in the block 411 and with which different subsets of the variables and signals fed to the block 411 are evaluated for the purpose of plausibility checking. As has already been stated in conjunction with step 502, the intermediate value Fμ_Plaus is assigned, after the initialization, a value which states that at present no friction coefficient information is available. As soon as one of the plausibility interrogations specified below is fulfilled, the intermediate value Fμ_Plaus is assigned a value which represents a slippery underlying surface. If, on the other hand, none of the following plausibility interrogations is fulfilled, the intermediate value Fμ_Plaus is assigned a value which represents an underlying surface with good grip.

The particular plausibility interrogations are as follows—it is to be noted that the vehicle under consideration is a vehicle with rear wheel drive, for which reason the rear wheels are the driven wheels and the front wheels are the non driven wheels:
has a slippery underlying surface been detected for one of the front wheels AND
does the value of the variable μPlausVA lie below a predetermined threshold value AND
is the brake light switch activated AND
is the outside temperature below a predefined threshold value?
has a slippery underlying surface been detected for both front wheels AND
is the value of the variable μPlausVA below a predefined threshold value AND
is the outside temperature below a predefined threshold value?
has a slippery underlying surface been detected for one of the rear wheels AND
does the value of the variable μPlausHA lie below a predefined threshold value AND
is the outside temperature below a predefined threshold value?
has a slippery underlying surface been detected for both rear wheels AND does the value of the variable μPlausHA lie below a predefined threshold value AND
is the outside temperature below a predefined threshold value?

The above threshold value for the outside temperature is, for example, +10° C. In addition to the plausibility interrogations mentioned above it is also possible to take into account plausibility interrogations in which, for example, the variable F_{Scheibenwischer} is evaluated or which are based on an evaluation with which it is detected whether a yaw rate control device which is contained in the vehicle is active or whether a traction slip control system which is contained in the vehicle is active or whether a brake slip control system which is contained in the vehicle is active.

The friction coefficient value Fμ is then determined as a function of the value of the intermediate variable Fμ_Plaus. The following statements are based on the assumption that the friction coefficient value Fμ contains, as has been already described in conjunction with FIG. 3, both a component which is intended for the block 310 and a component which is intended for the block 311. However, this is not intended to constitute any restriction. The following statements can also be applied or transferred to a case in which a single friction coefficient value Fμ is used for the two blocks 310 and 311.

As has already been stated in conjunction with step 502, the component of the friction coefficient value Fu which is intended for the block 310 is assigned, after the initialization, a value which states that at present there is no friction coefficient information available. This component of the friction coefficient value Fμ is referred to below as switch-over component for the sake of simplicity. If, after this initialization state, the intermediate variable Fμ_Plaus has directly a value which represents an underlying surface with good grip, the switch-over component is assigned a value which represents an underlying surface with good grip. If, after this value assignment, the intermediate value Fμ_Plaus has a value which represents a slippery underlying surface, the switch-over component is directly assigned a value which represents a slippery underlying surface. At the same time, a first distance value, which is for example of the order of magnitude of 500 meters, is assigned to an odometer. If the intermediate variable Fμ_Plaus has a value which represents a slippery underlying surface directly after the initialization state, a value which represents a slippery underlying surface is assigned directly to the switch-over component. In this case also, the first distance value is assigned to the odometer. In general terms, if the intermediate variable Fμ_Plaus has a value which represents a slippery underlying surface, the friction coefficient value Fμ is directly assigned a value which also represents a slippery underlying surface.

If the intermediate variable Fμ_Plaus has a value which represents an underlying surface with good grip after the switch-over component has been assigned the value which represents a slippery underlying surface, the switching over of the switch-over component to the value which represents the underlying surface with good grip is not performed until the vehicle has traveled for a predefined distance which corresponds to the first distance value and the value of the intermediate variable Fμ_Plaus has not changed again during this distance.

If the intermediate variable Fμ_Plaus has again a value which corresponds to a slippery underlying surface while the vehicle is traveling the distance corresponding to the first distance value, a second distance value which is greater than the first distance value is assigned to the odometer. The second odometer is of the order of magnitude of 1000 meters. This ensures that if the intermediate variable Fμ_Plaus again assumes the value which represents an underlying surface with good grip, the vehicle must travel for a longer distance before the friction coefficient value Fμ is assigned again the value which represents an underlying surface with good grip.

To summarize: the changing over of the switch-over component from a value which represents an underlying surface with good grip to a value which represents a slippery underlying surface takes place directly, i.e. without the vehicle having to travel for a predefined distance and thus without an intentionally brought about delay. In contrast, the changing of the switch-over component from a value which represents a slippery underlying surface to a value which represents an underlying surface with good grip takes place with a delay which depends on the distance covered by the vehicle. In this context, the distance to be covered by the vehicle is of different lengths and depends on whether the switching over of the intermediate variable Fμ_Plaus between a value which represents an underlying surface with good grip and a value which represents a slippery underlying surface takes place once or repeatedly.

As has already been stated in conjunction with step 502, the component of the friction coefficient value Fu which is intended for the block 311 is assigned, after the initialization, a value which states that at present no friction coefficient information is available. This component of the friction coefficient variant Fμ is referred to as a display component below for the sake of simplicity. If, directly after this initialization state, the intermediate variable Fμ_Plaus has a value which represents an underlying surface with good grip, a value which represents an underlying surface with good grip is assigned to the display component. If, after this value assignment, the intermediate variable Fμ_Plaus has a value which represents a slippery underlying surface, a value which represents a slippery underlying surface is not assigned to the display component until after a predefined period of time has passed. If during this time period the intermediate variable Fμ_Plaus has again a value which corresponds to an underlying surface with good grip, the value which represents an underlying surface with good grip is retained for the friction coefficient value Fμ. In other words, the switching over of the display component from a value which represents an underlying surface with good grip to a value which represents a slippery underlying surface does not take place until the intermediate variable Fμ_Plaus has the value which represents a slippery underlying surface for a predefined period of time. If, directly after the initialization state, the intermediate variable Fμ_Plaus has a value which represents a slippery underlying surface, in this case also a value which represents a slippery underlying surface is not assigned to the display component until after a predefined period of time has passed. In this case also, the value which represents an underlying surface with good grip is retained if the intermediate value Fμ_Plaus again has during this time period a value which corresponds to an underlying surface with good grip for the friction coefficient value Fμ. If the intermediate variable Fμ_Plaus has a value which represents an underlying surface with good grip after the display component has been assigned a value which represents a slippery underlying surface, the switching over of the display component to the value which represents the underlying surface with good grip is not performed until the vehicle has traveled for a distance which is defined by a third distance value and which is of the order of magnitude of 1000 meters, and during this distance the value of the intermediate variable Fμ_Plaus has not changed again. If the intermediate value Fμ_Plaus has again a value which corresponds to a slippery underlying surface while the vehicle is traveling the distance which corresponds to the third distance value, the odometer which is used to check whether the vehicle has traveled the distance corresponding to the third distance value is reset after a predefined period of time during which it is checked whether the intermediate variable Fμ_Plaus has again changed its value. Consequently, therefore, the vehicle must travel this distance again. If it is detected during the predefined period of time and the intermediate variable Fμ_Plaus has changed its value and again assumes the value which represents an underlying surface with good grip, the travel along the predefined distance which is already occurring is continued.

The display component can be summarized as follows: the changing of the display component from a value which represents an underlying surface with good grip to a value which represents a slippery underlying surface is not carried out until after a predefined period of time has passed and thus only with a delay. Even changing of the display component from a value which represents a slippery underlying surface to a value which represents an underlying surface with good grip does not take place immediately. This change also takes place with a delay, and to be precise does not take place until the vehicle has traveled a predefined distance. The outputting of the display component and thus the displaying of the snowflake symbol is advantageously suppressed if the variable FEAAZ indicates that a braking intervention is being performed in order to control the yaw rate.

After the step 509, the step 503 is carried out again.

Finally, the method according to the invention of the first embodiment and the method according to the invention of the second embodiment will be contrasted and common features and differences between the two methods will be indicated. Both methods have the following in common: wheel slip values λij are determined at various times during a predefined operating state of the vehicle. The frequency distribution of values is determined for these wheel slip values λij or for axle-related slip values λ_{VA}, λ_{HA} which are determined as a function of these wheel slip values λij. The friction coefficient value Fμ is determined by evaluating this frequency distribution of values. This procedure is to be understood as meaning that both the wheel slip values λij and the frequency distribution of values are determined during the predefined operating state of the vehicle, while the presence of the wheel slip values λij is a basis for the determination of the frequency distribution of values. In order to ensure that the friction coefficient value Fμ which is determined by evaluating the frequency distributions of values represents as well as possible the coefficient of friction which is respectively present between the underlying surface and the vehicle tire, the frequency distribution of values is determined only for wheel slip values which are present for a predefined operating state of the vehicle. However, this does not necessarily mean that the wheel slip values are determined only, i.e. exclusively, when the predefined operating state of the vehicle is present. This can be the case, but does not need to be. For example, the wheel slip values can be determined continuously and their frequency distribution of values is determined and evaluated only when the predefined operating state of the vehicle is present, as is apparent, for example, from FIG. 5 which is associated with the second embodiment. This procedure is appropriate in particular if the wheel slip values are, for example, made available by a slip control system which is present in the vehicle. As an alternative, the wheel slip values can be determined exclusively when the predefined operating state of the vehicle is present, as is apparent, for example, from FIG. 2 which is associated with the first embodiment. It is to be noted that continuous determination of the wheel slip values is also possible with the first embodiment.

As far as the determination and evaluation of the frequency distribution of values is concerned, the first and second embodiments differ as follows: in the first embodiment of the method according to the invention, the determination and evaluation of the frequency distribution of values are chronologically limited. Both are carried out within a defined time window. In addition, the frequency distribution of values is not determined until the predefined operating state of the vehicle is present. This determination is aborted if the predefined operating state of the vehicle is no longer present during ongoing determination. In contrast, in the second embodiment of the method according to the invention the determination and evaluation of the frequency distribution of values is chronologically unlimited, i.e. is carried out continuously. No time window is predefined. If the predefined operating state of the vehicle is present, the frequency distribution of values is determined in the form of updating ongoing. If the operating state of the vehicle is no longer present during the continuous determination of the frequency distribution of values, the determination of the frequency distribution is suspended or interrupted but not terminated. It is continued again after the operating state is present again.

In both embodiments it is conceivable that if the predefined operating state of the vehicle is not present at least one of the steps comprising determination of the wheel slip or determination of the frequency distribution of values or evaluation of the frequency distribution is not carried out.

The feeding of the different variables to the individual blocks which is represented in FIGS. 1, 3 and 4 using the arrows may be carried out, for example, by means of a CAN bus which is contained in the vehicle.

1. A method for determining a friction coefficient value (Fμ) which represents the coefficient of friction present between the underlying surface and a vehicle tire,
in which a wheel slip value (λij) is determined for at least one vehicle wheel, said value (λij) describing the wheel slip present at this vehicle wheel, and
in which the friction coefficient value (Fμ) is determined as a function of the wheel slip value (λij), in which case, during a predefined operating state of the vehicle, wheel slip values (λij) are determined at various times, in particular successive times,
for these wheel slip values (λij) or for axle-related slip values (λ_{VA}, λ_{HA}) that are determined as a function of these wheel slip values (λij), the frequency distribution of values is determined in such a way that the wheel slip values (λij) or the axle-related slip values (λ_{VA}, (λ_{HA}) are sorted in the sense of a classification into slip classes into which the slip range to be considered is subdivided, with the friction coefficient value (Fμ) being determined by evaluating this frequency distribution of values.

2. The method as claimed in claim 1, characterized in that the wheel slip values are determined as a function of a velocity value (vref), with a distinction being made between a case of driving and a case of braking during the determination of the velocity value (vref).

3. The method as claimed in claim 2, characterized in that during the determination of the velocity value (vref) gradient limitation is carried out in such a way that the change over time in the velocity value which is to be determined is limited.

4. The method as claimed in claim 1, characterized in that the velocity change value (a_{xFilt}) which describes the acceleration behavior and/or deceleration behavior of the vehicle and/or a yaw rate value (\dot{ψ}_{fil}) which describes the filtered yaw rate of the vehicle are additionally determined and taken into account during the determination of the friction coefficient value (Fμ).

5. The method as claimed in claim 1, characterized in that the predefined operating state of the vehicle is defined by a velocity change value (a_{xFilt}) and/or by a yaw rate value (\dot{ψ}_{fil}).

6. The method as claimed in claim 1, characterized in that the predefined operating state of the vehicle is straight-ahead travel during which minimum acceleration or minimum deceleration occurs.

7. The method as claimed in claim 1, characterized in that a velocity value (vref) which describes the vehicle reference velocity and/or a yaw rate value (\dot{ψ}_{fil}) which describes the filtered yaw rate of the vehicle and/or a lateral acceleration value (ay) which describes the lateral acceleration of the vehicle are determined and taken into account during the determination of the friction coefficient value (Fμ).

8. The method as claimed in claim 1, characterized in that the predefined operating state of the vehicle is defined by a velocity value (vref) and/or by yaw rate value (\dot{ψ}_{fil}) and/or by a lateral acceleration value (ay).

9. The method as claimed in claim 1, characterized in that the predefined operating state of the vehicle is straight-ahead travel occurring at a minimum velocity.

10. The method as claimed in claim 1, characterized in that the friction coefficient value (Fμ) is determined by evaluating the frequency distributions of values determined for an axle-related slip value (λ_{VA}, λ_{HA}), with the axle-related slip value which is determined for the driven axle being evaluated in the case of driving and the axle-related slip value which is determined for the non driven axle being evaluated in the case of braking.

11. The method as claimed in claim 1, characterized in that when brief regulating interventions of a yaw rate control device do occur the friction coefficient value (Fμ) is determined by evaluating the frequency distributions values determined for the wheel slip values (λij).

12. The method as claimed in claim 1, characterized in that wheel friction coefficient values (Fμij) are determined in each case by evaluating the frequency distributions of values determined for the wheel slip values (λij), with the friction coefficient value (Fμ) being determined as a function of the wheel friction coefficient values (Fμij).

13. The method as claimed in claim 12, characterized in that the friction coefficient value (Fμ) is determined as a function of various values which include the wheel friction coefficient values (Fμij), by means of plausibility interrogations.

14. The method as claimed in claim 13, characterized in that in the plausibility interrogations not only the wheel friction coefficient values (Fμij) are taken into account but also a variable (μPlausVA, μPlausHA) which constitutes a measure of the coefficient friction value utilized at the front axle or rear axle of the vehicle in the present driving situation, and/or a variable (FEAAZ) which contains information about the state of the closed-loop and/or open-loop control devices contained in the vehicle, and/or a variable (T_{auβen}) describing the outside temperature and/or a variable (F_{Regen}) originating from a rain sensor and/or a variable (F_{Scheibenwischer}) representing the operating state of the windshield wiper and/or a signal (BLS) representing the activation of the brake pedal by the driver.

15. The method as claimed in claim 1, characterized in that an estimate of the coefficient of friction utilized in the driving situation is taken into account in the determination of the friction coefficient value (Fμ).

16. The method as claimed in claim 1, characterized in that the friction coefficient value (Fμ) includes at least two values, with a first value representing a slippery underlying surface and a second value representing an underlying surface with good grip.

17. The method as claimed in claim 16, characterized in that the distance traveled by the vehicle and/or a time condition are taken into account when switching over between the values.

18. The method as claimed in claim 17, characterized in that the switching over from the one value which represents a slippery underlying surface to the other value which represents an underlying surface with good grip is not performed until the vehicle has covered a predefined distance.

19. The method as claimed in claim 17, characterized in that the switching over from the one value which represents an underlying surface with good grip to the other value which represents a slippery underlying surface is not performed until a predefined period of time has passed.

20. The method as claimed in claim 1, characterized in that during the predefined operating state of the vehicle the maximum value of a velocity change value (a_{xFilt}) is determined, with this value being taken into account during the evaluation of the frequency distribution of values.

21. The method as claimed in claim 1, characterized in that the wheel slip values (λij) are determined during the predefined operating state of the vehicle only for a predefined period of time which is defined by a minimum period of time and/or a maximum period of time.

22. The method as claimed in claim 1, characterized in that a variable (T_{auβen}) which describes the outside temperature and/or a variable (F_{Scheibenwischer}) which represents the operation of the windshield wiper are determined, with the determination of the frequency distribution of values being eliminated or aborted when the condition which is defined as a function of at least one of these two variables is present, and a predefined friction coefficient value (Fμ) being used instead.

23. The method as claimed in claim 1, characterized in that the frequency distribution of values which is determined is compared with predefined frequency distributions which are determined for different friction coefficient values, with that friction coefficient value which is associated with the predefined frequency distribution which corresponds to the determined frequency distribution of values being determined as the friction coefficient value.

24. The method as claimed in claim 23, characterized in that a velocity change value (a_{xFilt}) is used as a further feature for differentiating the predefined frequency distributions.

25. The method as claimed in claim 24, characterized in that in each case a value range for the velocity change value (a_{xFilt}) is assigned to the predefined frequency distributions, with the maximum value of a velocity change value (a_{xFilt}) being determined during the predefined operating state of the vehicle and a comparison of the determined frequency distribution of values being made only with the predefined frequency distributions in whose value range the maximum value of the velocity change value (a_{xFilt}) for the velocity change value (a_{xFilt}) is present.

26. The method as claimed in claim 23, characterized in that the value range for the wheel slip values or the axle-related slip values is divided into a plurality of slip classes, with the frequencies which are present for the individual slip classes being compared during the comparison of the determined frequency distribution of values with the predefined frequency distributions.

27. The method as claimed in claim 12, characterized in that the wheel friction coefficient values (Fμij) are determined as a function of a first variable (g) which describes the variation, related to the wheel slip, of the frequency distribution of values determined for the respective wheel slip value (λij), and a second variable which corresponds to the maximum frequency of occurrence of all the slip classes which are associated with the frequency distribution of values.

28. The method as claimed in claim 27, characterized in that the wheel friction coefficient values (Fμij) are determined by comparing the values of the first variable and of the second variable with value pairs which are predefined for conditions for an underlying surface with good grip and conditions for a slippery underlying surface.

29. A device for determining a friction coefficient value (Fμ) which represents the coefficient of friction present between the underlying surface and a vehicle tire,
in which a wheel slip value (λij) is determined for at least one vehicle wheel which describes the wheel slip present at this vehicle wheel,
in which the friction coefficient value (Fμ) is determined as a function of the wheel slip value (λij), and in which case, during a predefined operating state of the vehicle, wheel slip values (λij) are determined at various times, in particular successive times, for these wheel slip values (λij) or for axle-related slip values (λ_{VA}, λ_{HA}) that are determined as a function of these wheel slip values (λij), the frequency distribution of values is determined in such a way that the wheel slip values (λij) or the axle-related slip values (λ_{VA}, (λ_{HA}) are sorted in the sense of a classification into slip classes into which the slip range to be considered is subdivided, with the friction coefficient value (Fμ) being determined by evaluating this frequency distribution of values.

30. The device as claimed in claim 29, characterized in that the friction coefficient value (Fμ) is fed to a display device (105, 311) with which the information of the friction coefficient value (Fμ) is displayed to the driver, and/or in that the friction coefficient value (Fμ) is fed for further processing to other closed-loop and/or open-loop control devices (106) arranged in the vehicle, and/or in that the friction coefficient value (Fμ) is fed to a warning system (310) which is contained in the vehicle and which uses a navigation system to determine the course of the road over the stretch in front of the vehicle and which uses a display device (105, 311) to point out hazardous locations in the course of the road to the driver by including road signs symbolizing hazardous locations in the display.

31. The use of the method as claimed in claim 1 in a warning system which uses a navigation system to determine the course of the road over the stretch in front of the vehicle and which uses a display device (105) to indicate hazardous locations such as bends and/or traffic circles and/or intersections in the course of the road to the driver by including road signs symbolizing hazardous locations in the display.
